(19) United States
(12) Patent Application Publication
(10) Pub. No.: US 2007/0149697 A1
(43) Pub. Date: Jun. 28, 2007

(54) Elongation-increasing agent for the production of synthetic threads from melt-spinnable fiber-forming matrix polymers

(75) Inventors: Alexander Klein, Ingelheim (DE); Helmut SCHWIND, Hanau (DE); Michael WICKER, Seeheim-Jugenheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GBMH & CO. KG, Darmstadt (DE)

(21) Appl. No.: 10/554,923

(22) PCT Filed: Apr. 6, 2004
(86) PCT No.: PCT/EP04/03645

§ 371 Date: Oct. 24, 2006

(30) Foreign Application Priority Data
Apr. 30, 2003 (DE) 103 19 761.3

(51) Int. Cl. C08F 8/30

(52) U.S. Cl. 524/555; 524/556; 264/211.22

(57) ABSTRACT

The invention relates to an elongation-increasing agent which can be processed in an amorphous and thermoplastic manner, is made of radically polymerized, vinylic monomers, and is used for producing synthetic threads from a melt-spinnable fiber-forming matrix polymer that is incompatible with the elongation-increasing agent. The invention is characterized in that the elongation-increasing agent is thermally stabilized by adding an antioxidant substance such that said elongation-increasing agent is provided with a maximum total monomer content of 6 percent by weight after being thermally loaded at 290° C. for 30 minutes in an argon atmosphere. The invention further relates to granular plastic materials containing said elongation-increasing agent and a method for the production thereof. Also disclosed is a method for producing synthetic threads from a polymer mixture of a melt-spinnable, fiber-forming matrix polymer and an elongation-increasing agent in a melt-spinning process, and the subsequent use of said synthetic threads.

The present invention relates to an elongation-enhancing agent which is amorphous and thermoplastically processible, formed from free-radically polymerized vinylic monomer and adapted to production of synthetic fibre from a melt-spinnable fibre-forming matrix polymer which is incompatible with said elongation-enhancing agent. The invention further relates to plastics pellets containing the elongation-enhancing agent and a process for its production. The invention further relates to a process for producing synthetic fibre in a melt-spinning process from a polymer blend formed from a melt-spinnable fibre-forming matrix polymer and an elongation-enhancing agent and the further use of the synthetic fibre.

### PRIOR ART

The spinning of polymer blends into synthetic fibre is well known. Its purpose is to obtain a higher breaking extension in the spun fibre at a certain spinning speed than without modification through additive polymer. This is supposed to enable a higher draw ratio to be used to produce the final yarn and thereby increase the productivity of the spinning unit.

The increased productivity is supposed to bring an improvement in the economic efficiency of the manufacturing operation. This economic efficiency is compromised to a certain extent by production difficulties and costlier high speed equipment. The additional costs of the additive polymer have a substantial influence, so that there is even a point where the economic efficiency reaches zero, depending on the amount added. Moreover, the availability of the additive polymers on the market is an important factor. For these reasons, a multiplicity of the additives described in the literature do not even come into consideration for operation on a large industrial scale.

The producer or process originator has to consider the production chain as a whole and cannot be content with increasing the productivity of just a single step in the chain, for example spinning. Subsequent operations must not be impaired. More particularly, it is a main purpose of this invention not to narrow but preferably to improve the further processing conditions in subsequent steps, despite an increased spinning speed.

For instance, the prior art for the production of POYs reports very high breaking extensions for polymer blends even at a high spinning speed, which characterize a substantial reduction in the degree of orientation. Such as-spun filaments are known to be instable in storage and cannot be fed to and processed at high speeds in draw-texturing processes. Breaking extensions <70% reported for high spinning speeds in turn point to an appreciable crystallinity, which reduces the strengths which are obtainable in the texturing process.

Initial attempts to solve these problems are disclosed in EP 0 047 464 B (Teijin), DE 197 07 447 (Zimmer), DE 199 37 727 (Zimmer), DE 199 37 728 (Zimmer) and WO 99/07 927 (Degussa). EP 0 047 464 B concerns an undrawn polyester yarn prepared in a process in which 0.2-10% by weight of a polymer of the type —(—CH₂—CR₁R₂—)ₙ—, such as poly(4-methyl-1-pentene) or polymethyl methacrylate, is added to obtain improved productivity through an increase in the breaking extension of the as-spun fibre at speeds between 2 500-8 000 m/min and correspondingly higher draw ratios. The additive polymer has to be finely and uniformly dispersed by mixing, the particle diameter having to be <1 μm to avoid fibrillation. The special effect is said to be due to the cooperation of three properties—the chemical structure of the additive, which substantially prevents elongation of the additive molecules; the low mobility; and the compatibility of polyester and additive. The measures serve to increase productivity. No requirements are disclosed for draw texturing. Replicating this technical teaching as part of WO 99/07927 revealed a high additive consumption and an attendant impairment to quality and further processability.

WO 99/47735 (TEIJIN LTD.) discloses that the additives used in EP 0 047 464 B bring about the change in the friction characteristics of the fibre and that, as a result, it is not possible at all to achieve a satisfactory package build when winding up the fibre. According to WO 99/47735, a satisfactory winding performance of fibre based on polymer blends can only be achieved by using additives having a thermal deformation temperature in the range from 105 to 130° C., i.e. appreciably above that of polyester, and choosing specific spinning measures to achieve a radial distribution of the additive inclusions in the cross section of the fibre where the additive inclusions are reduced in the outer region of the fibre. To achieve the desired additive distribution, untypically high drawdown ratios are set by choosing large spinnerette die holes, which is usually accompanied by an increased fibre breakage rate. In addition, a specific formulation of the spin-finishing oil is described in order that a satisfactory winding performance may be achieved. The compatibility of these measures with large-scale industrial requirements, especially longer residence times in the spinning system and with further processing operations remains unanswered. The additive quantities used are not changed from their high level.

DE 197 07 447 (Zimmer) concerns the production of polyester or polyamide filaments having a breaking extension <180%. The addition of 0.05 to 5% by weight of a copolymer of 0 to 90% by weight of alkyl (meth)acrylate, 0 to 40% by weight of maleic acid or anhydride and 5 to 85% by weight of styrene to the polyester or polyamide allows a substantial increase in the spinning take-off speed.

DE 199 37 727 (Zimmer) discloses the production of polyester staple fibres from a polymer blend which contains 0.1 to 2.0% by weight of an incompatible amorphous polymeric additive which has a glass transition temperature in the range from 90 to 170° C. The ratio of the melt viscosity of the polymeric additive to the melt viscosity of the polyester component shall be in the range from 1:1 to 10:1.

DE 199 37 728 (Zimmer) relates to a process for producing HMLS filaments from polyester, a polymeric additive and optionally addition agents at a spinning take-off speed of 2 500 to 4 000 m/min. The polymeric additive shall have a glass transition temperature in the range from 90 to 170° C. and the ratio of the melt viscosity of the polymeric additive to the melt viscosity of the polyester component shall be in the range from 1:1 to 7:1.

WO 99/07 927 concerns the production of POYs by spinning polyester-based polymer blends at a take-off speed v of at least 2 500 m/min, the polyester being admixed with a second amorphous thermoplastically processible copolymer having a glass transition temperature of more than 100° C. The ratio of the melt viscosity of the copolymer to the melt viscosity of the polyester is in the range from 1:1 to 10:1. The polyester has added to it at least 0.05% by weight of copolymer and the maximum amount M. of copolymer added to the polyester depends on the take-off speed v, as follows

$$M = [ \frac{1}{1600} \cdot v ( \frac{m}{min} ) - 0.8 ] [ wt \% ] .$$

DE 10022889 A1 (ZIMMER AG) discloses specific extrusion and mixing conditions and also restrictions with regard to the residence time of the additives in the spinning system that ensure a commercially acceptable quality and yield, i.e. a commercially acceptable fibre breakage rate.

DE 100 63 286 A1 (ZIMMER AG) describes a specific combination of spinning measures adapted to allow a good package build when winding up filaments based on polymer mixtures. The application of this teaching requires inter alia the use of specific winders having a feeler roll which is driven at an at least 0.3% higher frequency than the winding mandrel.

These specific measures restricts the use of the additives to such manufacturing plants as are equipped with very specific hardware. The predominant number of existing manufacturing plants for polyester filaments would require cost-intensive retrofitment of additive-specific hardware and also installing and modifying works on the plant, associated with appreciable shutdown times. This greatly limits the adoption of this technology.

DE 101 15 203 A1 describes a process for producing synthetic fibre from a blend based on fibre-forming polymers. The process is characterized in that it utilizes an additive polymer which is obtainable by multiple initiation. Multiple initiation causes a reduction in the residual monomer content of the polymer and in particular to a further lowering in the number of fibre breakage events when producing synthetic fibre.

The thermal stabilization of free-radically polymerized methacrylate polymers by means of the addition of 2-mercaptoethyl alkylenecarboxylate compounds or by means of alkyl 3-mercaptopropionate compounds as molecular weight regulators in the polymerization. is known in principle (see for example EP-A 0 178 115).

The thermal stabilization of (meth)acrylate copolymers by means of copolymerization of acrylate monomers is known in principle (see for example Kunststoff-Handbuch “Polymethacrylate”, volume IX, pages 27-28, 1975).

Problem and Solution

Although the above-cited processes provide good and commercially acceptable fibre breakage rates, qualities a good winding performance (in use for filaments) and a good further processing performance during the spinning of such polymer blends under the operating conditions described, the industry nonetheless continues to demand processes for spinning polymer blends at an even smaller number of broken ends in order that the efficiency of the spinning process may be further increased. Another demand is for an improvement in the further processing properties of the synthetic fibre, especially in the case of POY, in the winding performance and in the further processing performance as it relates to draw texturing. Finally, such processes shall it be possible to scale up in their full breadth at acceptable cost and inconvenience in existing manufacturing plants in particular. There is further a desire for processes which permit the addition of the additive at an early stage of the operation, i.e. require one to few injection locations between the site of polymer production and spinning system and so reduce the capital investment required for the injection facilities and also plant complexity. There is a particular desire for such elongation-aiding agents and processes as permit the manufacture, on the basis of polyester and elongation-aiding agent, of a pellet which can be spun as a raw material in extruder spinning at high spinning speeds without any need for the elongation-aiding agent to be metered at spinning itself.

There is a constant need for the further development of elongation-enhancing agents. It was deemed to be an object of the present invention to provide improved elongation-enhancing agents for production of synthetic fibre in the melt-spinning process.

A particular problem which has hitherto not been addressed in this way in the prior art and which the inventors have decided to tackle resides in the adverse repercussions of secondary product from thermal decomposition of the elongation-aiding agents used in the cited processes in the course of the frequently prolonged thermal exposure of these elongation-aiding agents in large-scale industrial spinning plants. These repercussions are in particular increased fibre breakage rates and impairments of the winding and further processing performance, but also emissions in the spinning plant. Specifically in large-scale spinning plants there is preference for generating melt blends of the elongation-enhancing agent and of the matrix polymer which are then used to carry out the actual melt-spinning operation. For instance, the elongation-enhancing agent can be added in the polycondensation phase in the course of the production of polyesters such as polyethylene terephthalate for example. The molten mixture is then kept for a certain time at high temperatures in the polycondensation reactor and, for example, in the melt distribution lines of direct spinning systems until the actual melt-spinning operation starts. This leads to an appreciable thermal exposure of the elongation-enhancing agents.

There may for example be residence times of about 30 min at melt temperatures of around 290° C.

Alternatively, it is possible. first to produce plastics pellets of the elongation-enhancing agent and of the matrix polymer from a molten blend. These pellets have to be melted for the melt-spinning operation, and this entails a renewed thermal exposure for the elongation-enhancing agent. The inventors have determined that virtually all prior art elongation-enhancing agents will undergo thermal decomposition under these conditions, which can be monitored from the formation of monomeric constituents from the polymeric elongation-enhancing agents. The fraction of monomers formed by thermal decomposition is usually appreciably higher than the comparatively low residual monomer content resulting from the polymerization of the elongation-enhancing agent itself.

These monomeric constituents can lead to bubble formation especially on the outer surface of the synthetic fibre, which is reflected in broken ends, winding problems and impairments with regard to yarn quality. Since the monomeric constituents can only evaporate on the outer surface of the fibre while remaining in the interior, further problems arise in the course of further processing.

The so-called residual monomer content which is anyhow present in the polymer and comes from the polymerization itself is comparatively and, for the present purposes, usually negligibly small compared with the level of monomers which can form subsequently because of thermal decomposition, especially when the residual monomer content was lowered by multiple initiation in the course of additive synthesis.

These objects are achieved by an

Elongation-enhancing agent which is amorphous and thermoplastically processible, formed from free-radically polymerized vinylic monomer and adapted for production of synthetic fibre from a melt-spinnable fibre-forming matrix polymer which is incompatible with said elongation-enhancing agent, characterized in that the elongation-enhancing agent is thermally stabilized by addition of an antioxidative substance, so that it contains in total not more than 6% by weight of decomposition products detectable using the gas-chromatographic head space method after thermal exposure at 290° C. under argon for 30 min.

The gas-chromatographic head space method will be well known to those skilled in the art. Gas-chromatographic head space analysis is a method for determining vaporizable constituents in liquids and solids (inter alia of monomers in thermoplastics; determination of tempering time from the time of the sample vial being introduced into the preheated metal block thermostat at 290° C.; sample quantity about 30 mg in a 22 ml head space sample vial). The detectable decomposition products formed in the course of thermal exposure are predominantly monomers, for example methyl methacrylate or styrene, back-formed by depolymerization. In general, the fraction of nonmonomeric decomposition products is negligible.

In the case of elongation-enhancing agents which contain high fractions of methyl methacrylate and/or styrene, for example at least 50% or at least 60% and especially at least 70% by weight of methyl methacrylate and/or styrene, it is in practice sufficient to determine the level of these monomers after thermal exposure at 290° C. under argon for 30 min and report it as a measure of thermal stability. In these cases too the level of the monomers mentioned shall not be more than 6%, 4%, 3% or 2% by weight. Other decomposition products can be neglected in these cases.

The test method mentioned—thermal exposure of the elongation-enhancing agent at 290° C. under argon for 30 min—is suitable for simulating a thermal exposure as can occur under the above-described practical conditions and for selecting suitable thermally stabilized elongation-enhancing agents. A thermally stabilized polymer or copolymer is accordingly one which fulfils the abovementioned condition. Without thermal stabilization, the monomer content will generally be far above the upper limit mentioned, for example in the region of 10% by weight or higher.

A suitable thermal stabilization of the elongation-enhancing agent can be achieved for example by means of addition of an antioxidative substance and/or the presence of copolymerized C₁- to C₁₂- and preferably C₄- to C₈-alkyl acrylate and/or as a result of the polymerization having been carried out in the presence of a molecular weight regulator which is an alkyl 3-mercaptopropionate, where alkyl represents linear or branched C₁-C₁₈ hydrocarbyl groups. A polymer or copolymer is thermally stabilized for the purposes of the invention when it for example contains one of the measures mentioned or was prepared in the manner mentioned, so that it fulfils the claimed test conditions.

The elongation-enhancing agent may contain an antioxidative substance in an amount of 0.05% to 5% by weight.

The antioxidative substance may be selected from the class of the sterically hindered phenols and/or of the divalent thio compounds and/or of the trivalent phosphorus compounds and/or of the sterically hindered piperidine derivatives. Preference is given to the antioxidative substance octadecyl 3-(3,5-di-tert-butyl-4-hydroxyphenyl)propionate.

The antioxidative substance may be selected from the following compounds:
2,6-di-tert-butyl-4-methylphenol
octadecyl 3-(3,5-di-tert-butyl-4-hydroxylphenyl)-propionate (=Irganox 1076)
tetrakis(methylene 3-(3,5-di-tert-butyl-4-hydroxy-phenyl)propionate)methane
thiodiethylene bis(3-(3,5-di-tert-butyl-4-hydroxy-phenyl)propionate
1,3,5-tris(3,5-di-tert-butyl-4-hydroxybenzyl)isocyanurate
1,3,5-trimethyl-2,4,6-tris(3,5-di-tert-butyl-4-hydroxybenzyl)benzene
2,2′-methylenebis(4-methyl-6-tert-butylphenol) and mixtures thereof.

In addition to the sterically hindered phenols, it is possible to add further antioxidants or stabilizers in order that the polymer may be stabilized even better. Numerous stabilizers are commercially available and belong to the group consisting of organic phosphites, sterically hindered piperidine derivatives (HALS=Hindered Amine Light Stabilizers), thioethers, aliphatic sulphur compounds and mixtures thereof.

Suitable organic phosphites can be any aliphatic, aromatic or aliphatic-aromatic phosphites and thiophosphites, such as for example:
bis(2,4-di-tert-butyl)pentaerythritol diphosphite
tetrakis(2,4-di-tert-butylphenyl)4,4′-biphenylylene diphosphite
distearylpentaerythritol diphosphonite
trisnonyphenyl phosphite
tris(2,4-di-tert-butylphenyl) phosphite
diisodecyl pentaerythritol diphosphite
tetraphenyldipropylene glycol diphosphite
   and mixtures thereof.

Hindered piperidine derivatives can be for example:
poly[[6-[(1,1,3,3-tetramethylbutyl)amino]-5-triazine-2,4-diyl]-[(2,2,6,6-tetramethyl-4-piperidyl)-imino]hexamethylene-[2,2,6,6-tetramethyl-4-piperidyl)imino]]
2-(3′,5′-di-tert-butyl-2′-hydroxyphenyl)-5-chlorobenzotriazole
bis(2,2,6,6-tetramethyl-4-piperidinyl)sebacetate
bis(1,2,2,6,6-pentamethyl-4-piperidinyl)sebacetate
polymer from dimethyl succinate and 4-hydroxy-2,2,6,6-tetramethyl-1-piperidineethanol
   and mixtures thereof.

Suitable thioesters can be for example
dilauryl thiodipropionate
distearyl thiodipropionate
dimyristyl thiodipropionate
ditridecyl thiodipropionate
pentaerythritol tetrakis-(3-(dodecylthio)propionate)
   and mixtures thereof.

The antioxidative substance can advantageously be added to the monomer mixture before or during the polymerization without hindering the polymerization (see for example EP-A 254 348). This has the advantage of simplifying the production process for the thermally stabilized elongation-enhancing agent.

Preparing the polymer in the presence of the antioxidant ensures a homogeneous distribution of the antioxidant in the entire polymer even before the subsequent further processing via a melting process and hence substantially prevents thermal damage to the polymer in the course of the further processing and end compounding.

A further advantage of adding antioxidants during the polymerization is to be seen in the distinctly lower costs for producing a homogeneously thermally stabilized polymer without additional compounding step.

A suitable thermal stabilization of the elongation-enhancing agent can be achieved for example by a C₄- to C₁₂-alkyl acrylate being present in an amount of 1.5% to 15% by weight as a thermally stabilizing comonomer based on the total weight of the elongation-enhancing agent. The presence of n-butyl acrylate as a thermally stabilizing comonomer is particularly preferred.

The Elongation-Enhancing Agent

The elongation-enhancing agent can be polymerized from monomers of the general formula I 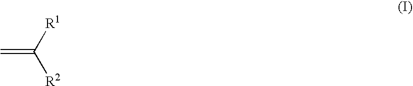
where R¹ and R² are the same or different and are each independently a substituent consisting of the optional atoms C, H, O, S, P and halogen atoms, the sum total of the molecular weight of R¹ and R² being at least 40 and at most 400 daltons.

The elongation-enhancing agent can be a thermally stabilized polymethyl methacrylate.

The elongation-enhancing agent can be a thermally stabilized copolymer formed from the following monomer units:
A=acrylic acid, methacrylic acid or CH₂═CR—COOR′, where R is a hydrogen atom or CH₃ group and R′ is a C₁₋₁₅-alkyl radical or a C₅₋₁₂-cycloalkyl radical or a C₆₋₁₄-aryl radical,
B=styrene or C₁₋₃-alkyl-substituted styrenes,
X=a C₁- to C₁₂-alkyl acrylate, preferably a C₄- to C₈-acrylate, other than A.
   the copolymer consisting of 60% to 98% by weight of A, 0% to 40% by weight of B, 0% to 15% by weight of X (sum total of A, B and X=100% by weight).

The elongation-enhancing agent can be a thermally stabilized copolymer formed from methyl methacrylate and n-butyl acrylate.

The elongation-enhancing agent can be a thermally stabilized copolymer formed from methyl methacrylate, styrene and n-butyl acrylate.

The elongation-enhancing agent can be a thermally stabilized copolymer formed from at least three of the following monomer units:
E=30% to 99% by weight of monomers selected from the group consisting of acrylic acid, methacrylic acid and compounds of the general formula CH₂═CR-COOR′, where R is a hydrogen atom or a CH₃ group and R′ is a C₁₋₁₅-alkyl radical or a C₅₋₁₂-cycloalkyl radical or a C₆₋₁₄-aryl radical, with optionally
F=0% to 50% by weight of monomers selected from the group consisting of styrene and C₁₋₃-alkyl-substituted styrenes, with optionally
G=0% to 50% by weight of monomers selected from the group of compounds consisting of compounds of the formula II, III and IV, 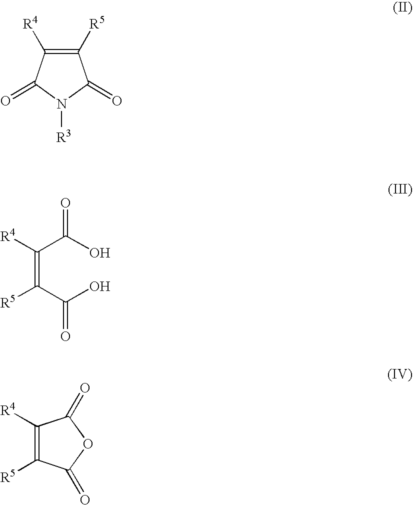
   where R³, R⁴ and R⁵ are each a hydrogen atom or a C₁₋₁₅-alkyl radical or a C₅₋₁₂-cycloalkyl radical or a C₆₋₁₄-aryl radical, with optionally
H=0% to 50% by weight of one or more ethylenically unsaturated monomers copolymerizable with E and/or with F and/or G from the group consisting of α-methylstyrene, vinyl acetate, acrylic esters, methacrylic esters other than E, acrylonitrile, acrylamide, methacrylamide, vinyl chloride, vinylidene chloride, halogen-substituted styrenes, vinyl ethers, isopropenyl ethers and dienes,
   the sum total of E, F, G and H together being equal to 100% by weight of the polymerizable monomers.

Preferably, the elongation-enhancing agent can consist of 60% to 94% by weight of E, 0% to 20% by weight of F, 6% to 30% by weight of G and 0% to 20% by weight of H, the sum total of E, F, G and H together again adding up. to 100% by weight.

Component H is an optional component. Although the advantages to be achieved according to the present invention are already obtainable by means of copolymers which contain components from groups E to G, the advantages to be achieved according to the present invention are also obtained when further monomers from group H are involved in the construction of the copolymer to be employed according to the present invention.

Component H is preferably chosen such that it has no adverse effect on the properties of the copolymer to be used according to the present invention.

Component H can be employed, inter alia, to modify the properties of the copolymer in a desired manner, for example through increases or improvements in the flow properties on heating to the melting temperature, or to reduce any residual colour in the copolymer or by using a polyfunctional monomer in order thereby to introduce a certain degree of crosslinking into the copolymer.

As well as for these reasons, H can also be chosen such that any copolymerization of components E to G is augmented or made possible in the first place, as in the case of MA and MMA, which do not copolymerize on their own, yet will copolymerize readily on addition of a third component such as styrene.

Useful monomers for this purpose include vinyl esters, esters of acrylic acid, for example methyl acrylate and ethyl acrylate, esters. of methacrylic acid other than methyl methacrylate, for example butyl methacrylate and ethylhexyl methacrylate, acrylonitrile, acrylamide, methacrylamide, vinyl chloride, vinylidene chloride, styrene, α-methylstyrene and the various halogen-substituted styrenes, vinyl ethers, isopropenyl ethers, dienes, for example 1,3-butadiene, and divinylbenzene. The reduction in copolymer colour may be particularly preferably achieved through the use of an electron-rich monomer, for example through the use of a vinyl ether, vinyl acetate, styrene or α-methylstyrene.

Particular preference among the compounds of component H is given to aromatic vinyl monomers, for example styrene or α-methylstyrene.

The elongation-enhancing agent can be a thermally stabilized terpolymer formed from methyl methacrylate, styrene and N-cyclohexylmaleimide.

The elongation-enhancing agent can be a copolymer formed from at least four of the following monomer units:
E=30% to 99% by weight of monomers selected from the group consisting of acrylic acid, methacrylic acid and compounds of the general formula CH₂═CR—COOR′, where R is a hydrogen atom or a CH₃ group and R′is a C₁₋₁₅-alkyl radical or a C₅₋₁₂-cycloalkyl radical or a C₆₋₁₄-aryl radical, with optionally
F=0% to 50% by weight of monomers selected from the group consisting of styrene and C₁₋₃-alkyl-substituted styrenes, with
G=0% to 50% by weight of monomers selected from the group of compounds consisting of compounds of the formula II, III and IV, 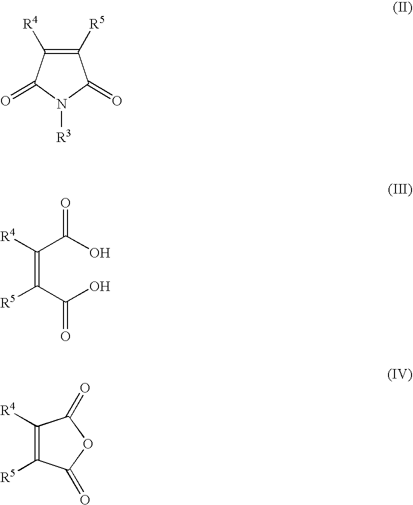
   where R³, R⁴ and R⁵ are each a hydrogen atom or a C₁₋₁₅-alkyl radical or a C₅₋₁₂-cycloalkyl radical or a C₆₋₁₄-aryl radical,
   with optionally
H=0% to 50% by weight of one or more ethylenically unsaturated monomers copolymerizable with E and/or with F and/or G from the group. consisting of α-methylstyrene, vinyl acetate, acrylic esters, methacrylic esters other than E, acrylonitrile, acrylamide, methacrylamide, vinyl chloride, vinylidene chloride, halogen-substituted styrenes, vinyl ethers, isopropenyl ethers and dienes,
X=1.5% to 15% by weight of a C₁- to C₁₂-alkyl acrylate, preferably of a- C₄- to C₈-alkyl acrylate, other than E
   the sum total of E, F, G, H and X together being equal to 100% by weight of the polymerizable monomers.

Component H is an optional component. Although the advantages to be achieved according to the present invention are already obtainable by means of copolymers which contain components from groups E to G, the advantages to be achieved according to the present invention are also obtained when further monomers from group H are involved in the construction of the copolymer to be employed according to the present invention.

Component H is preferably chosen such that it has no adverse effect on the properties of the copolymer to be used according to the present invention.

Component H can be employed, inter alia, to modify the properties of the copolymer in a desired manner, for example through increases or improvements in the flow properties on heating to the melting temperature, or to reduce any residual colour in the copolymer or by using a polyfunctional monomer in order thereby to introduce a certain degree of crosslinking into the copolymer.

As well as for these reasons, H can also be chosen such that any copolymerization of components E to G is augmented or made possible in the first place, as in the case of MA and MMA, which do not copolymerize on their own, yet will copolymerize readily on addition of a third component such as styrene.

Useful monomers for this purpose include vinyl esters, esters of acrylic acid, for example methyl acrylate and ethyl acrylate, esters of methacrylic acid other than methyl methacrylate, for example butyl methacrylate and ethylhexyl methacrylate, acrylonitrile, acrylamide, methacrylamide, vinyl chloride, vinylidene chloride, styrene, α-methylstyrene and the various halogen-substituted styrenes, vinyl ethers, isopropenyl ethers, dienes, for example 1,3-butadiene, and divinylbenzene. The reduction in copolymer colour may be particularly preferably achieved through the use of an electron-rich monomer, for example through the use of a vinyl ether, vinyl acetate, styrene or a-methylstyrene.

Particular preference among the compounds. of component H is given to aromatic vinyl monomers, for example styrene or α-methylstyrene.

The elongation-enhancing agent can be in particular a copolymer formed from methyl methacrylate, N-cyclohexylmaleimide and n-butyl acrylate.

The elongation-enhancing agent can further be a copolymer formed from methyl methacrylate, styrene, N-cyclohexylmaleimide and n-butyl acrylate.

Further Objects

It is considered one of the objects of the present invention to provide a process for producing synthetic fibre from a blend based on fibre-forming matrix polymers which permits the production of synthetic fibre in a simple manner at a lower fibre breakage rate. More particularly, the process shall make it possible to produce polyester-based POYs having breaking extension values in the range of 90%-165%, a high uniformity with regard to filament parameters and also a low degree of crystallization.

It is a further object of the present invention to provide a process for producing synthetic fibre from a blend based on fibre-forming matrix polymers that permits the use of unpelletized elongation-enhancing agents and hence is substantially more economical than existing processes.

It was yet a further object of the present invention to provide a process for spinning synthetic fibre which can be economically carried out universally on a large industrial scale, including in existing plants. It shall further be possible to wind up the fibre even when the feeler roll drive is raised by less than 0.3% compared with the winding mandrel drive of the winder or even using winders without separately driven feeler roll to produce a good package build at speeds above 3 800 m/min. This avoids the possibility of slippage between fibre and feeler roll, as may occur at large frequency differences between feeler roll and winding mandrel, and ensures a high uniformity in fibre dyeability in further processing. More particularly, the process of the invention shall make it possible to produce POYs at very high take-off speeds, preferably ≧2 500 m/min.

According to the invention, the synthetic fibre shall be simple to further process. More particularly, the POYs obtainable according to the invention shall be further processible in a drawing or draw-texturing operation, preferably at high processing speeds, with a low number of broken ends.

The present invention accordingly provides a process for producing synthetic fibre from a melt blend based on fibre-forming matrix polymers which includes the step of admixing the fibre-forming matrix polymer with at least one thermally stabilized elongation-enhancing agent (additive polymer) which is incompatible with the fibre-forming matrix polymer, in an amount of for example 0.05% to 5% by weight, based on the total weight of fibre-forming matrix polymer and incompatible additive polymer. This unforeseeable process makes it possible to produce synthetic fibre in a simple manner at a particularly lower breakage rate from a blend based on fibre-forming matrix polymers.

Preferably, the elongation-enhancing agent is formed by multiple initiation as per DE 101 15 203 A1, ensuring a low residual monomer content from the synthesis. This is possible through simultaneous initiation with various initiators or through successive multiple initiation.

Plastics Pellet

The present invention provides a plastics pellet comprising or consisting essentially of the elongation-enhancing agent and a melt-spinnable fibre-forming matrix polymer.

The fibre-forming matrix polymer may be a polyester, a polylactic acid, a polyamide or polypropylene. The melt-spinnable fibre-forming polyester is a polyethylene terephthalate, polyethylene naphthalate, polypropylene terephthalate or polybutylene tere-phthalate, in which case it may selectively contain up to 15 mol % of a copolymer and/or up to 0.5% by weight of a polyfunctional brancher component. Preference is given to a pellet whose level of monomer from thermal decomposition of the elongation-enhancing agent is reduced by thermal conditioning prior to melting in the spinning extruder. To this end, the pellet is lowered to less than 0.3% by weight based on the weight fraction of the elongation-enhancing agent in the pellet at a temperature which is higher, preferably at least 10° C. higher, than the glass transition temperature of the elongation-enhancing agent. To this end, the pellet is preferably thermally conditioned under vacuum, dry air or inert gas atmosphere for at least 4 hours. This can be sensibly done in the course of the drying of the matrix material and especially of the polyester. Furthermore, this conditioning is possible in the course of the solid state condensation of the matrix polymer, the reaction rate of the solid state condensation not being significantly impaired by the presence of the elongation-enhancing agent. This version of the process involves high temperatures and so is particularly in need of the use of the thermally stable elongation-enhancing agents of the invention. The level of elongation-enhancing agent in the pellet can be higher than the level needed for spinning, for example 5-30% by weight. This makes it possible to add the additive using the conventional master batch metering means.

The additive may more preferably be added in the course of the compounding of a master batch which comprises additional ingredients, for example pigments, optical brighteners or flame retardants.

Process for Producing a Plastics Pellet

The present invention provides a process for producing the plastics pellet wherein the molten elongation-aiding agent, before or after it has been mixed into the melt of the matrix polymer, is preferably transported through a degassing zone in which the melt is degassed, preferably by application of a vacuum, before pelletization takes place.

This makes it possible to produce a plastics pellet which, based on the weight fraction of the elongation-enhancing agent, contains less than 0.8% and preferably less than 0.6% by weight of monomer from thermal decomposition of the elongation-enhancing agent.

The elongation-aiding agent may preferably be melted using a single-screw extruder, in particular having at least one vacuum degassing zone or more preferably a twin-screw extruder, in particular having at least one vacuum degassing zone. The additive is metered either through gravimetrically controlled charging of the extruder with the elongation-aiding agent or volumetrically by means of a melt metering pump when the extruder alone is charged with the elongation-aiding agent. When twin-screw extruders and high throughputs are used, it is preferable to run the extruder underfed. When a single-screw extruder is used for melting unpelletized elongation-enhancing agent, it is preferable for the extruder cylinder to have grooves in the intake region. The mixing into the matrix material can take place in the extruder itself and/or downstream through static mixers. The gentle mixing-in using static mixing only is particularly preferable. The number of mixing elements we preferably so chosen that a pressure drop of less than 80 bar and more preferably of 5 to 50 bar results as the melt passes through the mixing sector.

Uses of the Elongation-Enhancing Agent

The elongation-enhancing agent of the invention can be used as an additive in the production of synthetic fibre from a melt-spinnable fibre-forming matrix polymer which is a polyester, a polylactic acid, a polyamide or polypropylene.

The melt-spinnable fibre-forming polyester can be a polyethylene terephthalate, polyethylene naphthalate, polypropylene terephthalate or polybutylene terephthalate, in which case the polyester may selectively contain up to 15 mol % of a copolymer and/or up to 0.5% by weight of a polyfunctional brancher component.

Process for Producing Synthetic Fibre

The present invention provides a process for producing synthetic fibre in a melt-spinning process from a polymer blend formed from a melt-spinnable fibre-forming matrix polymer and an elongation-enhancing agent, characterized in that the fibre-forming matrix polymer has added to it at least one elongation-enhancing agent according to the invention in an amount of 0.05% to 5% by weight, based on the total weight of fibre-forming matrix polymer with this elongation-enhancing agent.

The addition and mixing of the additive polymer with the matrix polymer may be carried out in a conventional manner. It is described for example in WO 99/07927 or DE 199 35 145 or DE 100 22 889, the disclosure of each of which is hereby explicitly incorporated herein.

The improved thermal stability of the novel additive polymers advantageously makes it possible to use the following addition methods on a large industrial scale without excessive back-formation of monomers occurring as a result of thermal decomposition of the additive polymers:

The matrix polymer and the elongation-enhancing agent may be introduced as a raw material in the form of a pellet into the production process for producing synthetic fibre.

Similarly, the addition of the elongation-enhancing agent to a melt-spinnable fibre-forming polyester may take place in the final stage of the polycondensation plant during the production of the polyester.

The addition of the elongation-enhancing agent to a melt-spinnable fibre-forming polyester may take place after the polyester melt has been discharged from the final stage of the polycondensation plant and is being transported to the direct spinning operation, the elongation-enhancing agent preferably being melted by means of a side stream extruder and the molten elongation-enhancing agent preferably being transported through a degassing zone in which the melt is degassed, by application of a vacuum, before the degassed melt is metered by means of a gear wheel metering pump into the stream of the polyester melt and mixed therewith by means of a static mixing sector.

The elongation-aiding agent may preferably be melted using a single-screw extruder, in particular having at least one vacuum degassing zone or more preferably a twin-screw extruder, in particular having at least one vacuum degassing zone. The additive is metered either through gravimetrically controlled charging of the extruder with the elongation-aiding agent or volumetrically by means of a melt metering pump. When twin-screw extruders and high throughputs are used, it is preferable to run the extruder underfed. When a single-screw extruder is used for melting unpelletized elongation-enhancing agent, it is preferable for the extruder cylinder to have grooves in the intake region. The mixing into the matrix material takes place downstream through static mixers. The number of mixing elements is preferably chosen so that a pressure drop of less than 80 bar and more preferably of 5 to 50 bar results as the melt passes through the mixing sector.

Preference is given to a spinning take-off speed of at least 2 500 m/min.

The fibre-forming matrix polymer can be in particular a thermoplastically processible polyester, such as polyethylene terephthalate, polyethylene naphthalate, polypropylene terephthalate or polybutylene terephthalate, in which case the polyester may selectively contain up to 15 mol % of a copolymer and/or up to 0.5% by weight of a polyfunctional brancher component.

Synthetic Fibre

Synthetic fibre is obtainable according to the invention by the described process obtainable.

Synthetic fibre comprises, contains or consists essentially of a polymer blend of polyester and the elongation-enhancing agent, the fibre containing less than 40 ppm of monomer from thermal decomposition of the elongation-enhancing agent.

The synthetic fibre can be used or further processed in a drawing or draw-texturing operation.

The synthetic fibre can be used or further processed for producing staple fibres.

The synthetic fibre can be used or further processed for producing nonwovens.

The synthetic fibre can be used. or further processed for producing industrial yarns.

At the same time, the process of the present invention has a number of further advantages. These include:
The process of the present invention can be carried out in a simple manner, on a large industrial scale and economically. More particularly, the process makes it possible to spin and wind at high take-off speeds.
Owing to the high uniformity of the synthetic fibre obtainable by the process, it is simple to achieve good package build to ensure uniform and substantially defect-free dyeing and further processing of the synthetic fibre.
The process of the present invention is particularly useful for producing polyester-based POYs having breaking extension values in the range of 90%-165%, a high uniformity with regard to the filament parameters and also a low degree of crystallization.
The synthetic fibre obtainable by the process can-be further processed in a simple manner, on a large industrial scale and economically. For example, the POYs of the present invention can be drawn or draw-textured at high speeds with a low number of broken ends.
The emission of monomer fumes at spinning is reduced.

The process of the present invention relates to the production of synthetic fibre from a melt blend based on fibre-forming matrix polymers.

The spinning can be effected not only by a direct spinning process, in which the elongation-enhancing agent is metered in the form of a melt into the melt of the matrix polymer, but also by an extruder spinning process, in which the elongation-enhancing agent is metered as a solid into the matrix polymer and subsequently melted therein. Further details concerning the processes mentioned can be taken from the prior art, for example EP 0 047 464 B, WO 99/07 927, DE 100 49 617 and DE 100 22 889, the disclosure of each of which is hereby explicitly incorporated herein.

In the context of the present invention, the term “synthetic fibre” comprehends all the kinds of fibre which are obtainable by spinning thermoplastically processible blends of synthetic polymers. These include staple fibres, textile filaments, such as flat yarns, POYs, FOYs and industrial filaments. Further details concerning synthetic fibre and also concerning the groups mentioned, especially with regard to their material properties and the customary production conditions, can be taken from the prior art, for example from Fourne “Synthetische Fasern: Herstellung, Maschinen und Apparate, Eigenschaften; Handbuch fur Anlagenplanung, Maschinenkonstruktion und Betrieb”, Munich, Vienna; Hanser Verlag 1995, and also DE 199 37 727 (staple fibres), DE 199 37 728 and DE 199 37 729 (industrial yarns) and WO 99/07 927 (POYs). The disclosure content of these references is therefore explicitly incorporated herein by reference.

In a particularly preferred embodiment of the present invention, the process of the present invention is used for producing staple fibres, flat yarns, POYs, FOYs or industrial filaments. The process of the present invention has been determined to be very useful for producing POYs.

Useful fibre-forming matrix polymers for the invention include thermoplastically processible polymers, preferably polyamides, such as nylon-6 and nylon-6,6, and polyesters. Mixtures or blends of different polymers are also conceivable. Preference for use in the present invention is given to polyesters, especially polyethylene terephthalate (PET), polyethylene naphthalate, polytrimethylene terephthalate (PTMT) and polybutylene terephthalate (PBT). In a particularly preferred embodiment of the present invention, the matrix polymer is polyethylene terephthalate, polytrimethylene terephthalate or polybutylene terephthalate, especially polyethylene terephthalate.

Homopolymers are preferred according to the invention. However, it is also possible to use copolymers, preferably polyester copolymers containing up to about 15 mol % of customary comonomers, for example diethylene glycol, triethylene glycol, 1,4-cyclohexanedimethanol, polyethylene glycol, isophthalic acid and/or adipic acid.

The polymers of the present invention may include, as further constituents, additives which are customary for thermoplastic moulding compositions and contribute to improved polymer properties. Examples of such additives include antistats, antioxidants, flame retardants, lubricants, dyes, light stabilizers, polymerization catalysts, polymerization assistants, adhesion promoters, delusterants and/or organic phosphites. These addition agents are used in a customary amount, preferably amounts of up to 10% by weight, preferably <1% by weight, based on 100% by weight of the polymer mixture.

A polyester used in the process of the present invention may also contain a small fraction (not more than 0.5% by weight) of brancher components, ie for example polyfunctional acids, such as trimellitic acid, pyromellitic acid, or tri- to hexavalent alcohols, such as trimethylolpropane, pentaerythritol, dipenta-erythritol, glycerol or corresponding hydroxy acids.

In the invention, the matrix polymer is mixed with an additive polymer in an amount of at least 0.05% by weight, and the additive polymer shall be amorphous and substantially insoluble in the matrix polymer. In essence, the two polymers are not compatible with each other and form two phases which can be distinguished under the microscope. The additive polymer shall furthermore preferably have a glass transition temperature (determined by DSC using a 10° C./min heating rate) of more than 90° C., in particular of more than 100° C., and be thermoplastically processible. The melt viscosity of the additive polymer shall be chosen in such a way that the ratio of its melt viscosity (measured at an oscillation rate of 2.4 Hz and at a temperature which is equal to the melting temperature of the matrix polymer plus 34.0° C. (290° C. for polyethylene terephthalate)) on extrapolation to the time zero to the melt viscosity of the matrix polymer (when measured under identical conditions) is in the range from 1:1 to 10:1. In other words, the melt viscosity of the additive polymer is at least the same as or preferably higher than that of the matrix polymer.

The ratio of the melt viscosity of the copolymer to that of the matrix polymer under the abovementioned conditions is preferably between 1.4:1 and 8:1. Particular preference is given to a ratio between 1.7:1 and 6.5:1 for the melt viscosities. Under these conditions, the average particle size of the additive polymer is 140-350 nm after extrusion from the spinnerette die.

The flow activation energy of the additive polymer is higher than that of the matrix polymer, higher than 80 kJ/mol in the case of polyester, in order that, during fibre formation, consolidation of the fibril structure of the additive may take place before the matrix material consolidates. For the production of polyester fibre it is with a view to the temperatures employed in further processing particularly favourable to use such additive polymers as have an ASTM D-648 thermal deformation temperature of 70 to 104° C. and preferably less than 105° C.

The amount of additive polymer to be added to the matrix polymer is between 0.05% by weight and 5% by weight, based on the total weight of the polymer blend. There are many applications, for example the production of POYs, where it is sufficient to add less than 1.5% and in the case of take-off speeds above 3 500 and up to 6 000 m/min or more even often less than 1.0%, which is an appreciable cost advantage.

The blending of the additive polymer with the matrix polymer is effected in a conventional manner as described for example in WO 99/07 927 or DE 199 35 145 or DE 100 22 889, the disclosure content of each of which is hereby explicitly incorporated herein by reference.

The polymer blend is spun at temperatures (which depend on the matrix polymer) in the range from 220 to 320° C.

Preparation of the Elongation-Enhancing Agents

The way to prepare the elongation-enhancing agents to be used according to the present invention is known per se. They can be prepared by bulk, solution, suspension or emulsion polymerization. Helpful information with regard to bulk polymerization is to be found in Houben-Weyl, Volume E20, Part 2 (1987), page 1145ff. Information with regard to solution polymerization is found ibid. at page 1156ff. The suspension polymerization technique is described ibid. at page 1149ff, while emulsion polymerization is described and illustrated ibid. at page 1150ff.

Particular preference for the purposes of the present invention is given to bead polymers whose particle size lies in a particularly favourable range. The additive polymers to be used according to the present invention, for example by being mixed into the melt of the fibre polymers, are particularly preferably in the form of particles having an average diameter of 0.1 to 1.0 mm. However, larger or smaller beads can also be employed.

Polymer blends of polyethylene terephthalate for textile applications, such as POYs, having a limiting viscosity number of about 0.55 to 0.75 dl/g and are preferably formed from elongation-enhancing agents having viscosity numbers in the range from 70 to 130 cm³/g.

Preference is given to an elongation-enhancing agent which is obtainable by multiple initiation. This has the advantage that an elongation-enhancing agent is obtained that has a comparatively low residual monomer content. The presence of residual monomers from incomplete addition polymerization can be as harmful as the monomers which additionally arise from the decomposition of the elongation-enhancing agent due to thermal exposure. A low residual monomer content contributes to a lower total level of monomers in the elongation-enhancing agent.

The term “multiple initiation” as used herein comprehends not only single or multiple supplementary initiation of a free-radical polymerization, i.e. the single or multiple renewed addition of initiator at later reaction times, but also free-radical polymerization in the presence of a mixture comprising at least two initiators having graduated. half-lives, the latter option being particularly preferred. “Graduated half-life” as used herein denotes that the at least two initiators each considered separately have different half-lives at a certain temperature or have the same half-life in different temperature ranges. Preference is given to using initiators which each have a half-life of one hour in temperature ranges which are at least 10° C. apart. The initiator selected from the individual temperature ranges can be a single compound for each range, but it is also possible to employ in each instance two or more initiators having appropriate half-lives from appropriate temperature ranges.

Such polymerizations are described for example in the documents U.S. Pat. Nos. 4,588,798, 4,605,717, EP 489 318, DE 199 17 987 and the references cited therein. The disclosure content of the cited documents is hereby explicitly included herein by reference.

It has been determined to be particularly advantageous for the purposes of the present invention to use an initiator mixture which includes an initiator I₁, having a half-life T₁ of one hour in the range from 70 to 85° C. and a further initiator I₂ having a half-life T₂ of one hour in the range from 85 to 100° C. Further initiators I₅ which can be used where appropriate preferably have decomposition temperatures Tn between T₁ and T₂.

The amount of the initiator mixture to be used can be varied within relatively wide limits; the amount of the initiators used can be used to control the polymerization time and also the polymerization temperature. The amounts used according to the present invention are specified in parts by weight of initiator per 100 parts by weight of monomer. It is advantageous to employ a total amount of about 0.05 to 1.0 part by weight of initiator mixture per 100 parts by weight of monomer, advantageously 0.05 to 0.5 part by weight of initiator mixture and especially 0.15 to 0.4 part by weight of initiator mixture per 100 parts by weight of monomer.

The weight ratio between the individual initiators in the initiator mixture can likewise be varied within relatively wide limits. The weight ratio between the individual initiators is preferably in the range from 1:1 to 1:10 and more preferably in the range from 1:1 to 1:4. Suitable amounts and mixing ratios can be determined in simple preliminary tests.

Useful initiators for the present invention include the customary initiators used for free-radical formation in free-radically initiated polymerizations. This includes compounds such as organic peroxides, such as dicumyl peroxide, diacyl peroxides, such as dilauroyl peroxide, peroxydicarbonates such as diisopropyl peroxy-dicarbonate, peresters such as tert-butyl peroxy-2-ethylhexanoate and the like. Other types of compounds capable of forming free radicals are also suitable for the purposes of the present invention. This includes in particular azo compounds such as 2,2′-azobisiso-butyronitrile and 2,2′-azobis-(2,4-dimethylvalero-nitrile).

Particularly useful initiator mixtures comprise components selected from the following initiators:
tert-amyl peroxypivalate half-life T (1 hour)=71° C.,
2,2′-azobis(2,4-dimethylvaleronitrile) T (1 hour)=71° C.,
di-(2,4-dichlorobenzoyl) peroxide T (1 hour)=72° C.,
tert-butyl peroxypivalate T (1 hour)=74° C.,
2,2′-azobis(2-amidinopropane) dihydrochloride T (1 hour)=74° C.,
di-(3,5,5-trimethylhexanoyl) peroxide T (1 hour)=78° C.,
dioctanoyl peroxide T (1 hour)=79° C.,
dilauroyl peroxide T (1 hour)=80° C.,
didecanoyl peroxide T (1 hour)=80° C.,
2,2′-azobis(N,N′-dimethyleneisobutyramidine) T (1 hour) =80° C.,
di-(2-methylbenzoyl) peroxide T (1 hour)=81° C.,
2,2′-azobisisobutyronitrile T (1 hour)=82° C.,
dimethyl 2,2′-azobisisobutyrate T (1 hour)=83° C.,
2,2′-azobis-(2-methylbutyronitrile) T (1 hour)=84° C.,
2,5-dimethyl-2,5-di-(2-ethylhexanoylperoxy)hexane T (1 hour)=84° C.,
4,4′-azobis(cyanopentanoic acid) T (1 hour)=86° C.,
di-(4-methylbenzoyl) peroxide T (1 hourj=89° C.,
dibenzoyl peroxide T (1 hour)=91° C.,
tert-amyl peroxy-2-ethylhexanoate T (1 hour)=91° C.,
tert-butyl peroxy-2-ethylhexanoate T (1 hour)=92° C.,
tert-butyl peroxyisobutyrate T (1 hour)=96° C.

Peroxidic initiators are most preferred for the purposes of the present invention.

One way to thermally stabilize the elongation-enhancing agent is to conduct the polymerization in the presence of a molecular weight regulator which is an alkyl 3-mercaptopropionate, where alkyl represents methyl, ethyl, n-butyl, 2-ethylhexyl and n-octadecyl, in customary amounts, for example 0.2% to 2% by weight, based on the polymerization batch. This surprising effect has not been understood.

The polymerization can be substantially or largely carried out under isothermal conditions. In a particularly preferred embodiment of the present invention, the polymerization is carried out in at least two steps. A first step comprises polymerizing at a comparatively low temperature, preferably at a temperature between 60 and 85° C. A second step continues the polymerization at a higher temperature, preferably at a temperature between 85 and 120° C. The residual monomer content of the elongation-enhancing agent is preferably less than 0.62% by weight, advantageously less than 0.47% by weight and preferably less than 0.42% by weight, each percentage being based on the total weight of the additive polymer. In a particularly preferred embodiment of the present invention, the residual monomer content of the elongation-enhancing agent is less than 0.37% by weight, preferably less than 0.30% by weight, advantageously less than 0.25% by weight and especially less than 0.20% by weight, each percentage being based on the total weight of the elongation-enhancing agent.

Here, the residual monomer content of the elongation-enhancing agent refers according to the present invention to the amount of monomer which remains in the polymer after polymerization and polymer isolation. The residual monomer content in the case of polymers produced by free-radical polymerization is customarily in the range from 0.65% by weight to 1.0% by weight, based on the total weight of the polymer. Processes for reducing the residual monomer content of a polymer are known from the prior art. For instance, the residual monomer content of polymer can be reduced by devolatilizing the polymer melt, preferably in an extruder and directly before spinning.

Flow Aids

It is further exceedingly advantageous in the context of the present invention to mix a flow aid into the elongation-enhancing agent. In this context, flow aid refers to any assistant mixed into pulverulent or granulated, especially hygroscopic, substances in small amounts to prevent the substances clumping or caking together and so ensure permanent free flow. Useful flow aids, which are also known as adhesives, anticaking agents or fluidifiers, include water-insoluble, hydrophobicizing or moisture-absorbing powders of diatomaceous earth, pyrogenic silicas, tricalcium phosphate, calcium silicates, Al₂O₃, MgO, MgCO₃, ZnO, stearates, fatty amines (see CD Rompp Chemie Lexikon—Version 1.0, Stuttgart/New York: Georg Thieme Verlag 1995). In the context of the present invention, such flow aids have been found to have only limited usefulness, since they are disadvantageous for the spinning process. First, they can become lodged in the spinning apparatus and so cause blockages in pipework and nozzles or dies and hence lead to system upsets. Secondly, these “extraneous materials” are liable to compromise the material properties of the resulting synthetic fibre and increase the fibre breakage rate during spinning.

According to the invention, polymers and/or copolymers are therefore particularly preferred for use as flow aids. The hereinbelow specified polymers and/or copolymers have been found to be particularly useful:

The flow aid can be a polymer obtainable by polymerization of monomers of the general formula (I): 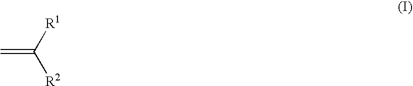
where R¹ and R² are substituents consisting of the optional atoms C, H, O, S, P and halogen atoms and the sum total of the molecular weight of R¹ and R² is at least 40. Exemplary monomer units include acrylic acid, methacrylic acid and CH₂═CR—COOR′, where R is an H atom or a CH₃ group and R′ is a C₁₋₁₅-alkyl radical or a C₅₋₁₂-cycloalkyl radical or a C₆₋₁₄-aryl radical, and also styrene and C₁₋₃-alkyl-substituted styrenes.

The flow aid can be a copolymer containing the following monomer units:
A=acrylic acid, methacrylic acid or CH₂═CR—COOR′, where R is an H atom or a CH₃ group and R′ is a C₁₋₁₅-alkyl radical or a C₅₋₁₂-cycloalkyl radical or a C₆₋₁₄-aryl radical,
B=styrene or C₁₋₃-alkyl-substituted styrenes,
the copolymer consisting of 60 to 98% by weight of A and 2 to 40% by weight of B, preferably of 83 to 98% by weight of A and 2 to 17% by weight of B and more preferably of 90 to 98% by weight of A and 2 to 10% by weight of B (sum total=100% by weight).

The flow aid can be a copolymer containing the following monomer units:
C=styrene or C₁₋₃-alkyl-substituted styrenes,
D=one or more monomers of the formula II, III or IV 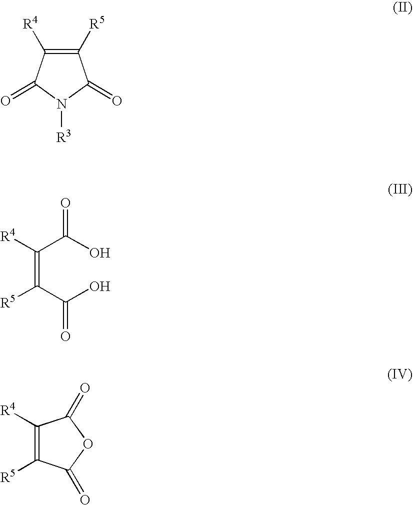
   where R³, R⁴ and R⁵ are each an H atom or a C₁₋₁₅-alkyl radical or a C₆₋₁₄-aryl radical or a C₅₋₁₂-cycloalkyl radical,
      the copolymer consisting of 15 to 95% by weight of C and 2 to 8.0% by weight of D, preferably of 50 to 90% by weight of C and 10 to 50% by weight of D and more preferably of 70 to 85% by weight of C and 15 to 30% by weight of D, the sum total of C and D being 100% by weight.

The flow aid can be a copolymer containing the following monomer units:.
E=acrylic acid, methacrylic acid or CH₂═CR—COOR′, where R is an H atom or a CH₃ group and R′ is a C₁₋₁₅-alkyl radical or a C₅₋₁₂cycloalkyl radical or a C₆₋₁₄-aryl radical,
F=styrene or C₁₋₃-alkyl-substituted styrenes,
G=one or more monomers of the formula II, III or IV 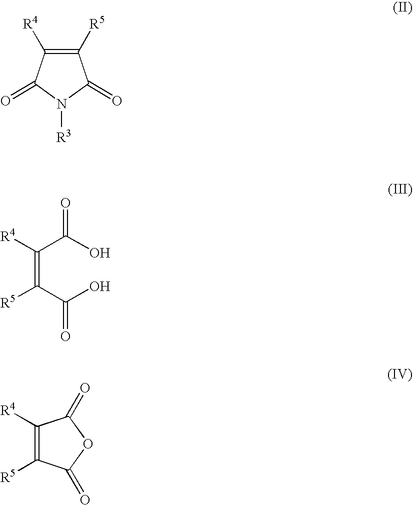
   where R³, R⁴ and R⁵ are each an H atom or a C₁l₁₅-alkyl radical or a C₅₋₁₂-cycloalkyl radical or a C₆₋₁₄-aryl radical,
H=one or more ethylenically unsaturated monomers which are copolymerizable with E and/or with F and/or G and are selected from the group consisting of a-methylstyrene, vinyl acetate, acrylic esters, methacrylic esters other than E, acrylonitrile, acrylamide, methacrylamide, vinyl chloride, vinylidene chloride, halogen-substituted styrenes, vinyl ethers, isopropenyl ethers and dienes,
   the copolymer consisting of 30 to 99% by weight of E, 0 to 50% by weight of F, 0 to 50% by weight of G and 0 to 50% by weight of H. preferably of 45 to 97% by weight of E, 0 to 30% by weight of F, 3 to 40% by weight of G and 0 to 30% by weight of H and more preferably of 60 to 94%. by weight of E, 0 to 20% by weight of F, 6 to 30% by weight of G and 0 to 20% by weight of H, the sum total of E, F, G and H being 100% by weight.

Component H is an optional component. Although the advantages to be achieved according to the present invention are already obtainable by means of copolymers which contain components from groups E to G, the advantages to be achieved according to the present invention are also obtained when further monomers from group H are involved in the construction of the copolymer to be employed according to the present invention.

Component H is preferably chosen such that it has no adverse effect on the properties of the copolymer to be used according to the present invention.

Component H can be employed, inter alia, to modify the properties of the copolymer in a desired manner, for example through increases or improvements in the flow properties on heating to the melting temperature, or to reduce any residual colour in the copolymer or by using a polyfunctional monomer in order thereby to introduce a certain degree of crosslinking into the copolymer.

As well as for these reasons, H can also be chosen such that any copolymerization of components E to G is augmented or made possible in the first place, as in the case of MA and MMA, which do not copolymerize on their own, yet will copolymerize readily on addition of a third component such as styrene.

Useful monomers for this purpose include vinyl esters, esters of acrylic acid, for example methyl acrylate and ethyl acrylate, esters of methacrylic acid other than methyl methacrylate, for example butyl methacrylate and ethylhexyl methacrylate, acrylonitrile, acrylamide, methacrylamide, vinyl chloride, vinylidene chloride, styrene, α-methylstyrene and the various halogen-substituted styrenes, vinyl ethers, isopropenyl ethers, dienes, for example 1,3-butadiene, and divinylbenzene. The reduction in copolymer colour may be particularly preferably achieved for example through the use of an electron-rich monomer, for example through the use of a vinyl ether, vinyl acetate, styrene or α-methylstyrene.

Particular preference among the compounds of component H is given to aromatic vinyl monomers, for example styrene or α-methylstyrene.

The flow aids mentioned are prepared in a conventional manner. They can be prepared by bulk, solution, suspension or emulsion polymerization. Helpful information with regard to bulk polymerization is to be found in Houben-Weyl, Volume E20, Part 2 (1987), page 1145ff. Information with regard to solution polymerization is found ibid. at page 1156ff. The suspension polymerization technique is described ibid. at page 1149ff, while emulsion polymerization is described and illustrated ibid. at page 1150ff. If necessary, the polymers have to be additionally ground.

Preference is given to flow aids whose particle size lies in a particularly favourable range. They are particularly preferably in the form of particles having an average diameter of 0.01 to 100 μm. However, it is also possible to use flow aids having larger or smaller particle sizes.

The imidated copolymer types can be prepared not only from the monomers using a monomeric imide but also by subsequent complete or preferably partial imidation of a copolymer containing the corresponding maleic acid derivative. These flow aids are obtained for example by complete or preferably partial reaction of the corresponding copolymer in the melt phase with ammonia or a primary alkyl- or arylamine, for example aniline (Encyclopedia of Polymer Science and Engineering Vol. 16 [1989], Wiley, page 78). The resulting copolymers have to be additionally ground, if necessary.

All the copolymers according to the present invention and also, as far as they exist, their nonimidated starting copolymers are obtainable commercially or can be prepared by a process familiar to one skilled in the art.

Particularly useful flow aids in the context of the present invention have a substantially identical chemical composition to the additive polymer used. The flow aid and the additive polymer used contain the same repeat units to an extent which is advantageously not less than 50% by weight, preferably not less than 60% by weight, more preferably not less than 70% by weight and especially not less than 80% by weight, each percentage being based on the total weight of the flow aid and of the additive polymer used, respectively. In this context, the term “repeat units” refers to the recurring units in the polymer which are derived from the monomers originally used.

Particularly advantageous results can be obtained when the flow aid and the elongation-enhancing agent used have the same repeat units to an extent which is not less than 90% by weight, preferably not less than 95% by weight and especially not less than 97% by weight, each percentage being based on the total weight of the flow aid and of the additive polymer used, respectively. In a very particularly preferred embodiment of the present invention, the polymer composition of the flow aid and the polymer composition of the additive polymer used are completely identical with regard to the repeat units.

It may additionally be advantageous to use a flow aid which has a similar weight average molecular weight to the additive polymer used. The weight average molecular weight of the flow aid is preferably less than 50%, advantageously less than 30% and especially less than 20% different- from that of the elongation-enhancing agent used.

The preferred concentration range for the flow aid in the additive polymer is 0.05 to 5.0% by weight and preferably 0.05 to 1.0% by weight, each percentage being based on the total weight of additive polymer and flow aid, and depends on the surface area and hence on the average diameter of the additive polymers. In the case of a bead polymer having an average particle size of 0.7 mm, the flow aid concentration is preferably in the range from 0.05 to 0.3% by weight. As the bead diameter decreases, the flow aid concentration required for the flow-furthering effect increases. When the flow aid concentration is too low, the flow-furthering effect will be insufficient, whereas excessively high flow aid concentrations will yield no further improvement in flowability, but instead give rise to pronounced, technically undesirable dusting due to the excessive, finely divided flow aid powder.

It is advantageous for the flow aid to be prepared by an emulsion polymerization process and isolated by spray drying. The spray drying operation can be carried out in a conventional manner. Illustrative descriptions of spray drying can be found in DE 332 067 or Ullmanns Enzyklopadie der technischen Chemie, 5th edition (1988,), B 2, page 4-23. Depending on the spraying assembly (one-material nozzle, two-material nozzle or atomizer disc), the particles obtained have an average particle diameter of 20 to 300 μm.

The mixing of elongation-enhancing agent and flow aid to obtain a very uniform (homogeneous) elongation-enhancing agent can be effected in a conventional manner. Further details are described for example in Ullmanns Enzyklopadie der technischen Chemie, 5th edition (1988) and also Rompps Chemie Lexikon (CD)-Version 1.0, Stuttgart/New York: Georg Thieme Verlag 1995.

Alternatively, the flow aid (once it has been prepared by emulsion polymerization) may also be directly applied, in the form of the aqueous emulsion, to the elongation-enhancing agent and be dried together with the latter.

It has been found to be exceedingly advantageous in the context of the present invention for the additive polymer, which is preferably dried using a fluidized bed dryer, and the spray-dried flow aid to be mixed using a fluidized bed dryer. Details concerning the fluidized bed process can likewise be taken from the technical literature, for example Ullmanns Enzyklopadie der technischen Chemie, 5th edition (1988) and also Rompps Chemie Lexikon (CD)-Version 1.0, Stuttgart/New York: Georg Thieme Verlag 1995.

The elongation-enhancing agent to be used according to the present invention may be granulated, if necessary. Granulating in this context refers to the production of pellets of the same shape and size. The polymer to be granulated is customarily melted in a preferably underfedly charged single- or twin-screw extruder, preferably degassed in the process and fed to a pelletizing machine. Comminution can be effected not only by cold pelletization but also by hot pelletization. In cold pelletization, the granulating die produces strands, strips or thin self-supporting films which, after solidification, are comminuted by a rotating blade. In hot pelletization, the plasticated polymer is pressed through the die and the emerging strand is comminuted by a rotating blade, which is customarily secured to the die plate. The melt is cooled after pelletizing, usually either by air or by water.

The synthetic fibre is produced from the polymer blends of the present invention by melt spinning using conventional spinning means as described for example in the printed publications DE 199 37 727 (staple fibres), DE 199 37 728 and DE 199 37 729 (industrial yarns) and WO 99/07 927 (POYs). The disclosure content of these references is hereby explicitly incorporated herein by reference.

Since the process has been determined to be particularly advantageous for producing Poys, a particularly preferred embodiment of the novel process for producing POYs will now be described. It will be readily apparent to one skilled in the art how to apply the teaching of the present invention to processes for producing other synthetic yarn.

POYs are preferably melt spun at spinning take-off speeds of at least 2 500 m/min. The filter pack used is equipped according to the known prior art with filter means and/or loose filter media (e.g. steel sand).

The molten polymer blend, after shearing and filtration in the die pack, is forced through the capillaries in the die plate. There follows a cooling zone in which the melt threads are cooled by cooling air to below their softening temperature to avoid sticking or jamming on the downstream thread guide. The configuration of the cooling zone is not critical, provided a homogeneous air stream which passes through the filament bundle uniformly is ensured. For instance, directly below the die plate there can be an air quiescent zone to retard cooling. The cooling air can be supplied from an air conditioning system by transverse or radial quenching or be taken by means of a cooling pipe from the environment by self-aspiration.

After cooling, the filaments are bundled and spin finished. This is accomplished using oiler pads to which a spin finish emulsion is supplied by metering pumps. The spin-finished fibre advantageously passes through entangling means to improve bundle coherency. Similarly, handling and safety elements are advisable before the fibre arrives at the winding assembly and is wound up there on cylindrical bobbin centres to form packages. The surface speed of the yarn package is automatically adjusted and is equal to the winding speed. The take-off speed of the fibre can be 0.2 to 2.5% higher than the winding speed, owing to the traversing movement of the fibre. Optionally, driven godets can be used downstream of the spin finishing step and upstream of the winding step. The surface speed of the first godet system is referred to as the take-off speed. Further godets can be used for drawing or relaxing.

Especially when using the elongation-aiding agents at high winding speeds, good bundle coherency is indispensable in order that a good package build without dropped ends due to high-tension threads may be achieved. A high number of entangling nodes are required in this connection. This is to be taken into account when selecting the spin-finishing conditions: spin finishes which lead to very high fibre-fibre friction frequently impair entangling in practice. It is better to have comparatively smooth spin finishes, which are applied in dilute emulsion (<10%).

The incompatibility of the two polymers is responsible for the fact that the additive polymer will form elongate particles in the matrix polymer which are radially symmetrical predominantly in the yarn transportation direction, immediately upon exit of the polymer blend from the spinnerette. The length/diameter ratio is preferably >2, where the diameter (d) was measured at right angles to the yarn transportation direction and the length was measured parallel to the yarn transportation direction. The best conditions were obtained when the midpoint particle diameter (arithmetic midpoint) d₅₀ was <400 nm and the fraction of particles >1 000 nm in a sample cross-section was below 1%.

The effect on these particles of the spinline extension ratio was demonstrated analytically. Investigations of the as-spun fibre by transmission electron microscopy (TEM) have shown that a fibril-like structure is present there. The midpoint diameter of the fibrils was estimated to be about 40 nm. The length/diameter ratio of the fibrils was >50. When these fibrils are not formed or when the additive particles are too large in diameter upon exit from the spinnerette or the size distribution is too non-uniform, which is the case when the viscosity ratio is insufficient, then the beneficial effect is lost.

The roller action described in the literature could not be demonstrated with the additive polymer according to the present invention. The evaluation of microscopic examinations of fibre cross and longitudinal sections suggests that the spinline extension tension is transferred to the additive fibrils as they form and that the polymer matrix undergoes a low-tension extension. As a consequence, the matrix deforms under conditions which result in a reduction in the orientation and suppression of spinning-induced crystallization. It is sensible to judge the effect by the as-spun by formation and by the processing characteristics.

It is further advantageous for the efficacy of the additives according to this invention for the copolymers to have a flow activation energy of at least 80 kJ/mol, i.e. a higher flow activation energy than that of the polymer matrix. Under this precondition it is possible for the additive fibrils to solidify before the polyester matrix and to take up an appreciable fraction of the spinning tension which is applied. Thus, the desired capacity increase for the spinning plant can be achieved.

The above-described preferred embodiment of the process according to the present invention is useful for the high speed spinning not only of POY fibre having a POY (single) filament linear density of >3 dtex to 20 dtex or more, but also of POY filament linear densities <3 dtex per filament, especially microfilaments of 0.2 to 2.0dtex per filament.

The process of the present invention, as a consequence of the added additive polymer, which is obtainable by multiple initiation, has a fibre breakage rate which is distinctly reduced compared with prior art processes. In a preferred embodiment of the present invention, POYs having a linear density >3 dtex per filament are produced with a fibre breakage rate of less than 0.75 breaks per metric ton of polymer blend, advantageously less than 0.5 breaks per -metric ton of polymer blend and preferably less than 0.4 breaks per metric ton of polymer blend.

The synthetic fibre obtainable by the process according to the invention can be used direct in the present form or else further processed in a conventional manner. In a particularly preferred embodiment of the present invention, it is used for producing staple fibres. Further details concerning the production of staple fibres can be taken from the prior art, for example from the printed publication DE 199 37 727 and the references cited therein.

In a further particularly preferred embodiment of the present invention, POYs produced by the process of the present invention are drawn or draw textured. In this context, the following observations are important for the further processing of the spun fibre in the draw-texturing process at high speeds: spun fibre according to this invention which is to be used as feed yarn for draw texturing—and is customarily known as POY—is preferably produced at take-off speeds- ≧2 500 m/min, more preferably >3 500 m/min and most preferably >4 000 m/min. These yarns have to have a physical structure which is characterized by a specific degree of orientation and a low degree of crystallization. Useful parameters for characterizing the yarn are the breaking extension, the birefringence, the crystallinity and the boil-off shrinkage. The polyester-based polymer blend according to the present invention is characterized by a breaking extension of not less than 85% and not more than 180% for the POY. The boil-off shrinkage is 32-69% and the birefringence is between 0.030 and 0.075, the crystallinity is less than 20% and the breaking tenacity is at least 17 cN/tex. The POY breaking extension is preferably between 85 and 160%. Conditions are particularly favourable when the POY breaking extension is between 109 and 146%, the POY breaking tenacity is concurrently at least 22 cN/tex and the Uster value is not more than 0.7%.

Synthetic POYs obtainable in this manner are particularly suitable for further processing in a drawing or draw-texturing operation. The number of broken ends will continue to be lower in the further processing operation. The draw-texturing is effected at different speeds depending on filament linear density, speeds ≧750 m/min and preferably ≧9.00 m/min being used for normal linear density filaments ≧2 dtex per filament (final linear density). Microfilaments and fine linear densities (final linear density) <2 dtex per filament are preferably processed at speeds between 400 and 750 m/min. The process is particularly advantageous for these linear densities and especially for microfilaments between 0.15 and 1.10 dtex (final linear density) per filament.

The draw ratios to be employed for the POYs specified are between 1.35 and 2.2, POYs having a comparatively low degree of orientation preferably being subjected to draw ratios at the upper end of the range, and vice versa. In draw texturing, the draw ratio is influenced by tension surging as a function of the processing speed. It is therefore particularly preferable to employ draw ratios as per the formula:
Draw ratio=5·10⁻⁴·w(m/min)+b
where
w=draw-texturing speed in m/min
b=a constant between 1.15 and 1.50.
   Elongation-Enhancing Agent/Matrix Polymer Viscosity Ratios

The ratio of the melt viscosity of the copolymer to the melt viscosity of the matrix polymer may preferably be in the range from 1:1 to 10:1. The amount of copolymer added to the matrix polymer may be for example at least 0.05% by weight (based on the polymer) and at most an amount M, M being given by the formula

$$M = [ \frac{1}{1600} \cdot v ( \frac{m}{min} ) - 0.8 ] [ \% by weight ] .$$

Preferably, the matrix polymer has added to it, in an amount of at least 0.05% by weight, an elongation-enhancing agent which shall be amorphous and substantially insoluble in the matrix polymer. In essence, the two polymers are not compatible with each other and form two phases which can be distinguished under the microscope. The elongation-enhancing agent advantageously also has a glass transition temperature (determined by DSC using a 10° C./min heating rate) of more than 90° C. and is thermoplastically processible.

The melt viscosity of the elongation-enhancing agent can be chosen in such a way that the ratio of its melt viscosity (measured at an oscillation rate of 2.4 Hz and at a temperature which is equal to the melting temperature of the matrix polymer plus 34.0° C. (290° C. for polyethylene terephthalate)) on extrapolation to the time zero to the melt viscosity of the matrix polymer (when measured under identical conditions). is between 1:1 and 10:1. In other words, the melt viscosity of the elongation-enhancing agent is at least the same as or preferably higher than that of the polyester. Optimum efficiency can be achieved through the choice of a specific viscosity range for the elongation-enhancing agent or through the choice of a specific viscosity ratio of elongation-enhancing agent and matrix polymer, for example polyester.

Optimized viscosity ratios make it possible to minimize the amount of additive added. As a result, the economic efficiency of the process becomes particularly high and particularly favourable processing properties are achieved. The particularly preferred viscosity ratio for the use of polymer blends to produce synthetic filament yarns is above the range which the literature identifies as favourable for the blending of two polymers.

Owing to the high flow activation energy of the additive polymers there is a dramatic increase in the viscosity ratio in the fibre-forming region after the polymer blend has exited from the spinnerette die. The choice of a favourable viscosity ratio achieves a particularly narrow particle size distribution for the additive in the polyester matrix and combination of the viscosity ratio with a flow activation energy of distinctly more than that of polyester (PET about 60 kJ/mol), i.e. more than 80 kJ/mol and preferably more than 100 kJ/mol, gives the requisite fibril structure for the additive in the as-spun fibre. The high glass transition temperature compared with polyester ensures a rapid consolidation of this fibril structure in the as-spun fibre. The maximum particle sizes for the additive polymer are about 1 000 nm immediately upon emergence from the spinnerette die, whereas the midpoint particle size is 400 nm or less.

Preferably, the ratio of melt viscosity of the elongation-enhancing agent to the matrix polymer is between 1.4:1 and 8:1. Particular preference is given to a ratio of the melt viscosities between 1.7:1 and 6.5:1. Under these conditions, the average particle size of the additive polymer can be 220-350 nm for example.

The amount of copolymer added to the polyester is at least 0.05% by weight in general. There are many applications where it is sufficient to add less than 1.5% and in the case of take-off speeds above 3 500 and up to 6 000 m/min or higher even often less than 1.0%, which is an appreciable cost advantage.

Amounts of Elongation-Enhancing Agent Added

The maximum amount of elongation-enhancing agent to be added relative to that of the matrix polymer is for example equal to an amount M, where M can be defined by the following formula as a function of the spinning take-off speed v:

$$M = [ \frac{1}{1600} \cdot v ( \frac{m}{min} ) - 0.8 ] [ \% by weight ] .$$

Maximum amounts to be added in the range from 3 500 to 6 000 m/min for spinning speeds are thus 1.39% by weight and 2.95% by weight, respectively.

To obtain a particularly good economic efficiency, the upper limit for the elongation-enhancing agent to be added can be defined for take-off speeds of more than 2 900 m/min in terms of a quantity M*, where

$${M}^{*} = [ \frac{1}{1650} \cdot v ( \frac{m}{min} ) - 1.73 ] [ \% by weight ] .$$

This formula would produce add quantities between 0.39% and 1.92% by weight for spinning speeds of 3 500 to 6 000 m/min.

When take-off speeds are more than 4 200 m/min, the amount of elongation-enhancing agent to be added to the matrix polymer is preferably not less than- a quantity N, but preferably not less than 0.05% by weight, where

$$N = [ \frac{1}{3510} \cdot v ( \frac{m}{min} ) - 1.14 ] [ \% by weight ] .$$

For take-off speeds of 4 200 to 6 000 m/min the minimum amount would thus be between 0.057% and 0.57% by weight.

When the aforementioned preferred viscosity ratio of additive polymer to polyester is complied with, the amount of elongation-enhancing agent to be added relative to that of the matrix polymer, which can be a polyester for example, is preferably equal to a quantity P, where P=P+0.2% by weight, but not less than 0.05% by weight, and where

$${P}^{*} = [ \frac{1}{2270} \cdot v ( \frac{m}{min} ) - 1.45 ] [ \% by weight ] .$$

for take-off speeds of more than 3 900 m/min.

In this preferred case, the amount of elongation-enhancing agent to be added can thus be between 0.07% by weight and 0.39% by weight for spinning speeds of 3 900 to 6 000 m/min.

These formulae can in principle also for spinning speeds of above 6 000 m/min to about 12 000 m/min.

The Matrix Polymer

Useful fibre-forming matrix polymers are preferably thermoplastically processible polyesters, such as polyethylene terephthalate (PET), polyethylene naphthalate, polyprolylene terephthalate, polybutylene terephthalate. These are mostly homopolymers. However, it is also possible to use copolymers of these polyesters having a fraction of up to about 15. mol % of customary comonomers, for example diethylene glycol, triethylene glycol, 1,4-cyclohexanedimethanol, polyethylene glycol, isophthalic acid and/or adipic acid.

The polymers may additionally include addition agents, such as catalysts, stabilizers, optical brighteners and delustrants. The polyester may also contain a small fraction (not more than 0.5% by weight) of brancher components, i.e. for example polyfunctional acids, such as trimellitic acid, pyromellitic acid, or tri- to hexavalent alcohols, such as trimethylolpropane, pentaerythritol, dipentaerythritol, glycerol or corresponding hydroxy acids.

Mixing Operations and Shear Rates

The mixing of the elongation-enhancing agent with the matrix polymer may be effected by addition as a solid to the matrix polymer chips in the extruder inlet using a chips mixer or gravimetric metering or alternatively by melting the additive polymer, metering by means of a gear pump and injection into the melt stream of the matrix polymer. A homogeneous distribution can subsequently be achieved by mixing in the extruder and/or by means of static or dynamic mixers. Advantageously, a defined particle distribution is set through a specific choice of mixer and duration of mixing before the melt blend is conveyed through product distribution lines to the individual spinning positions and spinnerette dies. Mixers having a shear rate of 16 to 128^{sec-1} and a mixer residence time of at least 8 sec will be found advantageous. The product of shear rate (s⁻¹) and the 0.8th power of the residence time (in sec) shall be in the range from 250 to 2 500 and preferably in the range from 300 to 600.

Shear rate is here defined as the superficial shear rate (s⁻¹) times the mixer factor, the mixer factor being a characteristic parameter of the type of mixer. For Sulzer SMX types, for example, this factor is about 7-8. The superficial shear rate y is calculated as per

$$γ = \frac{4 \cdot {10}^{3} \cdot F}{π \cdot δ \cdot {R}^{3} \cdot 60} [ s - 1 ]$$

and the residence time τ (s) as per

$$τ = \frac{F}{{V}_{2} \cdot ɛ \cdot δ \cdot 60}$$

where
F=polymer pump rate (g/min)
V₂ =internal volume of empty tube (cm³)
R=empty-tube diameter (mm)
ε=empty-volume fraction (0.84 to 0.88 for Sulzer SMX types)
δ=nominal density of polymer blend in melt (about 1.2 g/cm³)
   Temperatures

Not only the mixing of the two components but also the subsequent spinning of the polymer blend is generally carried out at temperatures (which depend on the matrix polymer) in the range from 220 to 320° C.

Production of Synthetic Filaments

The production of synthetic filaments from the matrix polymer and the elongation-enhancing agent by high-speed spinning and take-off speeds >2 500 m/min is preferably accomplished using conventional spinning means. The filter pack is fitted in accordance with the known prior art with filter means and/or loose filter media (steel sand for example).

The molten polymer blend, after shearing and filtration in the die pack, is forced through the capillaries in the die plate. There follows a cooling zone in which the melt threads are cooled by cooling air to below their softening temperature to avoid sticking or jamming on the downstream thread guide. The configuration of the cooling zone is not critical, provided a homogeneous air stream which passes through the filament bundle uniformly is ensured. For instance, directly below the die plate there can be an air quiescent zone to retard cooling. The cooling air can be supplied from an air conditioning system by transverse or radial quenching or be taken by means of a cooling pipe from the environment by self-aspiration.

After cooling, the filaments are bundled and spin finished. This is accomplished using oiler pads to which a spin finish emulsion is supplied by metering pumps. The spin-finished thread advantageously passes through entangling means to improve bundle coherency. Similarly, handling and safety elements are advisable before the fibre arrives at the winding assembly and is wound up there on cylindrical bobbin centres to form packages. The surface speed of the yarn package is automatically adjusted and is equal to the winding speed. The take-off speed of the fibre can be 0.2 to 2.5% higher than the winding speed, owing to the traversing movement of the fibre. Optionally, driven godets can be used downstream of the spin finishing step and upstream of the winding step. The surface speed of the first godet system is referred to as the take-off speed. Further godets can be used for drawing or relaxing.

Especially when using the elongation-aiding agents at high winding speeds, good bundle coherency is indispensable in order that a good package build without dropped ends due to high-tension threads may be achieved. A high number of entangling nodes are required in this connection. This is to be taken into account when selecting the spin-finishing conditions: spin finishes which lead to very high fibre-fibre friction frequently impair entangling in practice. It is better to have comparatively smooth spin finishes, which are applied in dilute emulsion (<10%).

The incompatibility of the two polymers is responsible for the fact that the additive polymer will form elongate particles in the matrix polymer which are radially symmetrical predominantly in the yarn transportation direction, immediately upon exit of the polymer blend from the spinnerette. The length/diameter ratio is preferably >2. The best conditions were obtained when the midpoint. particle diameter (arithmetic midpoint) d₅₀ was ≦400 nm and the fraction of particles >1 000 nm in a sample cross-section was below 1%.

The effect on these particles of the spinline extension ratio was demonstrated analytically. Investigations of the as-spun fibre by transmission electron microscopy (TEM) have shown that a fibril-like structure is present there. The average diameter of the fibrils was estimated to be about 40 nm. The length/diameter ratio of the fibrils was >50. When these fibrils are not formed or when the additive particles are too large in diameter upon exit from the spinnerette or the size distribution is too non-uniform, which is the case when the viscosity ratio is insufficient, then the beneficial effect is lost.

The roller action described in the literature could not be demonstrated with the thermally stabilized elongation-enhancing agent of the present invention. The evaluation of microscopic examinations of fibre cross and longitudinal sections suggests that the spinline extension tension is transferred to the additive fibrils as they form and that the polymer matrix undergoes a low-tension extension. As a consequence, the matrix deforms under conditions which result in a reduction in the orientation and suppression of spinning-induced crystallization. It is sensible to judge the effect by the as-spun filament formation and by the processing characteristics.

Flow Activation Energy

It is further advantageous for the efficacy of the elongation-enhancing agents according to this invention for the copolymers to have a flow activation energy of at least 80 kJ/mol, i.e. a higher flow activation energy than that of the polymer matrix. Under this precondition it is possible for the additive fibrils to solidify before the polyester matrix and to take up an appreciable fraction of the spinning tension which is applied. Thus, the desired capacity increase for the spinning plant can be achieved.

Spun Fibre Structure

Spun fibre structure is essentially developed in the drawdown zone beneath the spinnerette die. The length of the drawdown zone is varied through the spinline take-off speed in the case of unmodified polymer. Typical values for pre-yarns at conventional take-off speeds of at least 2 500 m/min are lengths of about 300 mm, preferably—for POY—≧250 mm to ≦700 mm. The process of the present invention extends the drawdown zone compared with conventional spinning. The sudden necking of the filaments which is observed at high speeds is suppressed. The change in the spinline speed along the drawdown path assumes a value which is equal to that of conventional POY produced at 3 200 m/min.

The process of the present invention is useful for the high-speed spinning not only of POY fibre having a POY (single) filament linear density of >3 dtex to 20 dtex of more but also of POY filament linear densities <3 dtex, especially microfilaments of 0.2 to 2.0 dtex per filament.

Further Processing or Uses of Synthetic Fibre

The synthetic fibre can be further processed in a draw-texturing operation at high speeds. Synthetic fibre as per this invention for use as a feed yarn for draw texturing—usually known as POYs—is produced at take-off speeds ≧2 500 m/min, preferably >3 500 m/min and more preferably >4 000 m/min. These yarns shall have a physical structure which comprises a specific degree of orientation and a low degree of crystallization. Useful parameters for characterizing these properties are breaking extension, birefringence, crystallinity and boil-off shrinkage. A suitable polymer blend may for example have a breaking extension of not less than 85% and not more than 180% for PET as-spun fibre (POY). The boil-off shrinkage is preferably 32-69%, the birefringence is usually between 0.030 and 0.075, the crystallinity is preferably less than 20% and the breaking tenacity is advantageously not less than 17 cN/tex. More preferably, the breaking extension is between 85 and 160% for as-spun polyethylene terephthalate (PET) fibre for example. Conditions are particularly favourable when the breaking extension of PET as-spun fibre is between 109 and 146%, the breaking tenacity is at the same time not less than 22 cN/tex and the Uster value is not more than 0.7%.

Draw texturing may be done at different speeds depending on filament linear density, speeds ≧750 m/min and preferably ≧900 m/min being used for normal linear density filaments >2 dtex per filament (final linear density). Microfilaments and fine final linear densities <2 dtex per filament are preferably processed at speeds between 400 and 750 m/min. The process is particularly advantageous for these linear densities and especially microfilaments between 0.15 and 1.10 dtex (final linear density) per filament.

The draw ratios to be employed for the as-spun fibre specified are preferably between 1.35 and 2.2, fibre having a comparatively low degree of orientation preferably being subjected to draw ratios at the upper end of the range, and vice versa. In draw texturing, the draw ratio is influenced by tension surging as a function of the processing speed. It is therefore particularly preferable to employ draw ratios as per the formula:
Draw ratio=5·10⁻⁴·w(m/min)+b
where
w=draw-texturing speed in m/min
b=a constant between 1.15 and 1.50.
   Reduction of High-Boiling Decomposition Products

When the elongation-aiding agents are used on a large industrial scale, the formation of high-boiling decomposition products is a problem as well as the offgassing of volatile decomposition products (monomers). High-boiling decomposition products may impair the yields at spinning through increased broken ends and poorer winding characteristics. Furthermore, high-boiling decomposition products may become deposited on the equipment and lead to impairments there. Such deposits may form on metal surfaces in the spinning system and have to be removed again therefrom. Such deposits may form at spinnerette holes and contribute to too thin fibre and broken ends. This compromises process consistency and fibre quality. High-boiling decomposition products reduce filter lives, spinnerette lives and spinnerette wipe cycles and hence the yield of the spinning operation. The invention accordingly has for its object to control the formation of high-boiling decomposition products.

This object is achieved according to the invention by an elongation-enhancing agent which is amorphous and thermoplastically processible, formed from free-radically polymerized vinylic monomer, adapted for production of synthetic fibre from a melt-spinnable fibre-forming matrix polymer which is incompatible with said elongation-enhancing agent and containing not more than 0.05% by weight of residues from lubricant additives and/or not more than 0.06% by weight of residues from initiator-derived products. The elongation-enhancing agent may be thermally stabilized by addition of an antioxidative substance, so that it contains in total—as described earlier—not more than 6% by weight of decomposition products detectable using the gas-chromatographic head space method after thermal exposure at 290° C. under argon for 30 min. The presence or the amount of high-boiling decomposition products in the elongation-enhancing agent can be determined by gas chromatography for example.

Residues from lubricant additives in the elongation-enhancing agent which amount to not more than 0.05%, preferably not more than 0.03% and more preferably not more than 0.01% by weight can be achieved by preparing the elongation-enhancing agent without lubricants being added at all or being added in concentrations not higher than 0.02% by weight.

Residues from initiator-derived products in the elongation-enhancing agent which amount to not more than 0.06% and preferably not more than 0.04% by weight can be achieved by employing additional purifying steps to reduce as far as possible, or substantially completely remove, initiators used in the preparation of the elongation-enhancing agent. A suitable additional purifying step can take the form for example of a vacuum degassing of the melt in the extruder, with or without employment of entraining agents, such as for example water or monomer (methyl methacrylate for example).

Further suitable additional purifying steps can take the form for example of coagulating the polymer, with or without coagulation-aiding agents and/or additional washing steps, dewatering the polymer melt in a twin-screw extruder having degassing and dewatering zones or the like.

Preparation of Elongation-Enhancing Agents:

### EXAMPLES

The elongation-enhancing agents (additive polymers) to be used according to the present invention are prepared in a conventional manner. They can be prepared by bulk, solution, suspension or emulsion polymerization. Helpful information with regard to bulk polymerization is to be found in Houben-Weyl, Volume E20, Part 2 (1987), page 1145ff. Information with regard to solution polymerization is found ibid. at page 1156ff. The suspension polymerization technique is described ibid. at page 1149ff, while emulsion polymerization is described and illustrated ibid. at page 1150ff.

Particular preference for the purposes of the present invention is given to bead polymers whose particle size lies in a particularly favourable range. The additive polymers to be used according to the present invention, for example by being mixed into the melt of the fibre polymers, are particularly preferably in the form of particles having an average diameter of 0.1 to 1.0 mm. However, larger or smaller beads can also be employed.

For the purposes of the present invention, the additive polymer has a residual monomer content of not more than 0.45% by weight, advantageously not more than 0.35% by weight and preferably not more than 0.25% by weight, each percentage being based on the total weight of the additive polymer. In a particularly preferred embodiment of the present invention, the residual monomer content of the additive polymer is in the range from not less than 0.05% by weight to not more than 0.25% by weight, each percentage being based on the total weight of the additive polymer.

Here, residual monomer content of the elongation-enhancing agent (additive polymer) refers according to the present invention to the amount of monomer which remains in the additive polymer after polymerization and polymer isolation. The residual monomer content in the case of polymers produced by free-radical polymerization is customarily in the range from 0.4% by weight to 1.0% by weight, based on the total weight of the polymer. Processes for reducing the residual monomer content of the polymer are known from the prior art. For instance, the residual monomer content of polymer can be reduced by degassing the polymer melt, preferably in an extruder directly before spinning. In addition, it is also possible to obtain polymers having a reduced residual monomer content through judicious choice of the polymerization parameters.

In a preferred embodiment of the present invention, the additive polymers are obtained by a free-radical polymerization using a plurality -of initiators having different half-lives (see for example DE 101 15 203 A1).

In the context of the present invention it -is further exceedingly advantageous to admix the additive polymer with so-called flow aids (see for example DE 102 10 018 A1).

1. Preparation of Elongation-Enhancing Agents

### Examples

A mixture of 2 400 g of completely ion-free water, 0.324 g of KHSO₄ and 41.1 g of a 13 percent aqueous solution of polyacrylic acid was heated to 40° C. in a 5 1 polymerization vessel equipped with heating/cooling jacket, stirrer, reflux condenser and thermometer. A mixture of the constituents indicated in Table 1 was then added with stirring. The batch was polymerized at 80° C. for 130 minutes and at 98° C. for 60 minutes and then cooled down to room temperature. The polymer beads were filtered off, washed thoroughly with completely ion-free water and dried in a fluidized bed dryer at 80° C.

TABLE 1a

| | | Comparison | | | | | |
|---|---|---|---|---|---|---|---|
| | Unit | A | Ex. 1 | Ex. 2 | Ex. 3 | Ex. 4 | Ex. 5 |
| Methyl methacrylate | g | 2188.8 | 2188.8 | 2116.8 | 2188.8 | 2188.8 | 2188.8 |
| Styrene | g | 211.2 | 211.2 | 211.2 | 211.2 | 211.2 | 211.2 |
| n-Butyl acrylate | g | — | — | 72.0 | — | — | — |
| TGEH¹⁾ | g | 3.46 | 3.6 | 3.46 | — | 3.55 | 3.46 |
| t-DDM²⁾ | g | 2.16 | 2.28 | 2.23 | — | 2.26 | 2.16 |
| EHMP³⁾ | g | — | — | — | 4.44 | — | — |
| Dilauroyl peroxide | g | 4.8 | 4.8 | 4.8 | 4.8 | 4.8 | 4.8 |
| TAPEH⁴⁾ | g | 2.4 | 2.4 | 2.4 | 2.4 | 2.4 | 2.4 |
| Stearic acid⁶⁾ | g | 1.2 | 1.2 | 1.2 | 1.2 | 1.2 | 1.2 |
| Irganox 1076⁵⁾ | g | — | 48.0 | — | — | 36.0 | 24.0 |

TABLE 1b

| | | | | | | | | Ex. 12 |
|---|---|---|---|---|---|---|---|---|
| | | | | | | | | (Com- |
| | | | | | | | | parison |
| | Unit | Ex. 6 | Ex. 7 | Ex. 8 | Ex. 9 | Ex. 10 | Ex. 11 | C) |
| Methyl methacrylate | g | 2188.8 | 2116.8 | 2116.8 | 2116.8 | 2188.8 | 2188.8 | 2376 |
| Styrene | g | 211.2 | 211.2 | 211.2 | 211.2 | 211.2 | 211.2 | — |
| n-Butyl acrylate | g | — | 72.0 | 72.0 | 72.0 | — | — | 24 |
| TGEH¹⁾ | g | 3.26 | — | 3.6 | — | — | 3.46 | 3.0 |
| t-DDM²⁾ | g | 2.02 | — | 2.28 | — | — | 2.16 | 2.25 |
| EHMP³⁾ | g | — | 4.56 | — | 4.8 | 4.8 | — | — |
| Dilauroyl peroxide | g | 4.8 | 4.8 | 4.8 | 4.8 | 4.8 | 4.8 | 3.6 |
| TAPEH⁴⁾ | g | 2.4 | 2.4 | 2.4 | 2.4 | 2.4 | 2.5 | 2.4 |
| Stearic acid | g | 1.2 | 1.2 | 1.2 | 1.2 | 1.2 | — | 1.2 |
| Irganox 1076⁵⁾ | g | 12.0 | 48.0 | 48.0 | — | 48.0 | — | — |

¹⁾2-ethylhexyl thioglycolate
²⁾tert-dodecyl mercaptan
³⁾ethylhexyl mercaptopropionate
⁴⁾tert-amy peroxy 2-ethylhexanoate
⁵⁾octadecyl 3-(3,5-di-tert-butyl-4-hydroxyphenyl)-propionate
⁶⁾technical grade mixture of stearic acid and palmitic acid

The dried polymer beads were subsequently admixed with 0.1 part by weight of a spray-dried MMA-styrene emulsion polymer and blended in a fluidized-bed dryer for about 5 minutes (as per extensive description in DE 102 10 018).

This gave a more than 95% yield of polymer beads having DIN 7745 viscosity numbers, residual MMA contents and average particle diameters as per the data reported in Table 2.

TABLE 2

| | Viscosity | | Midpoint |
|---|---|---|---|
| | number | MMA content | particle size |
| Ex. | ccm/g | % by weight | mm |
| Comparison A | 100 | 0.23 | 0.247 |
| 1 | 97.1 | 0.36 | 0.654 |
| 2 | 96.5 | 0.08 | 0.477 |
| 3 | 112 | 0.29 | 0.602 |
| 4 | 99.1 | 0.34 | 0.438 |
| 5 | 98.9 | 0.33 | 0.376 |
| 6 | 102 | 0.3 | 0.462 |
| 7 | 109 | 0.08 | 0.448 |
| 8 | 94.2 | 0.28 | 0.45 |
| 9 | 111 | 0.1 | 0.441 |
| 10 | 108 | 0.24 | 0.43 |
| 11 | 103 | 0.24 | 0.59 |
| 12 | 101.5 | 0.22 | n.d. |
| (Comparison C) | | | |
| 13 | 96.2 | 0.14 | n.d. |
| 14 | 95.9 | 0.16 | n.d. |

A mixture of 93.5 parts by weight of methyl methacrylate, 6.5 parts by weight of styrene, 0.035 part by weight of tert-butyl peroxy-2-ethylhexanoate and 0.075 part by weight of methyl 3-mercaptopropionate is continuously fed at a rate of 3 385 g/h into a 2.4 1 capacity stirred reactor maintain at 150° C. The reaction mixture has a steady-state polymer content of about 45.5% by weight. Reaction mixture is continuously removed at a rate corresponding to the feed stream and a solution of 45 parts by weight octadecyl 3-(3,5-di-tert-butyl-4-hydroxyphenyl)propionate in 575 parts by weight of methyl methacrylate is metered into this polymer syrup at a rate of 115.7 g/h. After passing through an SMX static mixer from Sulzer Chemtech, the mixture is heated to 180° C. in a heat exchanger and subsequently fed to a degassing extruder. In fact, a single-screw extruder having a screw diameter of 20 mm and a length of 25 D is operated in the temperature range of 240-250° C. and at decreasing pressures from 1 to 0.01 bar (vacuum). The monomer vapours are drawn off, condensed and recycled to generate the starting reaction mixture. The polymer melt is extruded in the form of round strands about 2 mm in thickness, which are led through a waterbath and, after cooling down to below the softening temperature, are comminuted to form a pellet.

The resulting polymer possesses a composition of methyl methacrylate and styrene=91.2:8.8% by weight and has a solution viscosity number of 96.2 cm³/g and an MVR (ISO 1133, 250° C., 10 kg) of 7.2 cm³/10 min.

### Example 14

A mixture of 94.5 parts by weight of methyl methacrylate, 5.5 parts by weight of methyl acrylate, 0.03 part by weight of tert-butyl peroxy-2-ethylhexanoate and 0.093 part by weight of methyl 3-mercaptopropionate is continuously fed at a rate of 3 390. g/h into a 2.4 1 capacity stirred reactor maintained at 150° C. The reaction mixture has a steady-state polymer content of about 44% by weight. Reaction mixture is continuously removed at a rate corresponding to the feed stream and a solution of 50.75 parts by weight octadecyl 3-(3,5-di-tert-butyl-4-hydroxy-phenyl)propionate in 650 parts by weight of methyl methacrylate is metered into this polymer syrup at a rate of 116 g/h. After passing through an SMX static mixer from Sulzer Chemtech, the mixture is heated to 180° C. in a heat exchanger and subsequently fed to a degassing extruder. In fact, a single-screw extruder having a screw diameter of 20 mm and a length of 25 D is operated in the temperature range of 240-250° C. and at decreasing pressures from 1 to 0.01 bar (vacuum). The monomer vapours are drawn off, condensed and recycled to generate the starting reaction mixture. The polymer melt is extruded in the form of round strands about 2 mm in thickness, which are led through a waterbath and, after cooling down to below the softening temperature, are comminuted to form a pellet. The resulting polymer possesses a composition of methyl methacrylate and methylacrylate=96:4% by weight and has a solution viscosity number of 95.9 cm³/g and an MVR (ISO 1133, 250° C., 10 kg) of 6.5 cm³/10 min.

2. Determination of Thermal Stability of Elongation-Enhancing Agents

Thermal stability is determined by the following method:
About 30 mg of the sample to be investigated are weighed into a 22 ml head space sample vial.
The open sample vials are transferred to a glove box, inertized with argon and sealed inside the glove box with a combination of PTFE-laminated silicone disc, ring washer and aluminium bead cap.
The sealed sample vials are removed from the glove box and tempered in a metal block thermostat equipped with drilled holes in the dimensions of the sample vials at 290° C. (temperature control by means of calibrated thermocouple) for 10, 20 or 30 min (tempering time measured from time of introducing the sample vial into the preheated metal block thermostat at 290° C.).
After cooling to room temperature, a syringe is used to meter 4 ml of N,N-dimethylformamide through the septum and the residue is completely dissolved therein at 50° C. in the metal block thermostat by temporary shaking (dissolving operation takes about 30-60 min.
After shaking, the sample should be allowed to stand usually for about 10 min in order that the solution can drain off the lid or septum. It is only then that a further 4 ml of DMF are added and subsequently the sample vial is sealed with a fresh septum.

The sample vials are placed in the autosampler of a head space sampler and are analysed according to the principle of static head space chromatography, The DMF solvent is flushed ack by backflush technology.

| | |
|---|---|
| Head space settings: | |
| sample temperature: | 130° C. |
| pressure build-up time: | 2 min |
| needle temperature: | 135° C. |
| injection time: | 0.10 min |
| transfer line temperature: | 150° C. |
| residence time: | 0.20 min |
| thermostating time | 20 min |
| cycle time: | 30 min |
| GC settings: | |
| columns | 2 × 30 m wide bore capillary GC columns |
| | ID 0.53 mm; film 1.00 μm; phase: 100% |
| | polyethylene glycol |
| | e.g. HP-INNOWax (from Agilent) |
| carrier gas/flow: | nitrogen 5.0 ml/min |
| oven temperature: | 90° C. isothermal |
| injector temperature: | 150° C. |
| detector temperature: | 320° C. (FID) |
| backflush on: | 9.0 min |
| backflush off: | 25.0 min |
| Equipment: | |

Autosystem XL/HS 40 XL head space gas chromatograph
(from Perkin Elmer)
The monomer fractions formed are evaluated via an
external calibration.

The results of the tempering runs are summarized in the Tables 3 and: only the methyl methacrylate (MMA) and styrene contents are reported, the fraction of other monomers (butyl acrylate or methyl acrylate) being negligible (<0.08% by weight).

TABLE 3

| | | MMA | MMA | MMA |
|---|---|---|---|---|
| | MMA | content | content | content |
| | content | after | after | after |
| | after | 10 min | 20 min | 30 min |
| | 0 min | temper | temper | temper |
| Comparison A | 0.25 | 3.35 | 9.9 | 12.9 |
| Comparison B | 0.37 | 1.8 | 4.1 | 7.17 |
| 1 | 0.35 | 0.6 | 1.19 | 1.14 |
| 2 | 0.08 | 0.8 | 1.86 | 3.45 |
| 3 | 0.29 | 1.96 | 2.83 | 5.75 |
| 4 | 0.35 | 1.3 | 1.6 | 1.9 |
| 5 | 0.34 | 1.5 | 2 | 2.2 |
| 6 | 0.29 | 1.5 | 2.1 | 2.5 |
| 7 | 0.07 | 1.3 | 2.8 | 3.8 |
| 8 | 0.28 | 0.77 | 0.88 | 0.97 |
| 9 | 0.08 | 1.3 | 1.6 | 3.8 |
| 10 | 0.23 | 1.2 | 2.2 | 1.7 |
| 11 | 0.22 | 5.67 | 7.76 | 12.74 |
| (Comparison C) | | | | |
| 12 | 0.18 | 6.1 | 13.9 | 23.4 |
| (Comparison D) | | | | |
| 13 | 0.14 | 0.88 | 1.66 | 2.66 |
| 14 | 0.16 | 0.65 | 1.00 | 1.42 |

* Comparison B = commercially available copolymer formed from 99% by weight of methyl methacrylate and 1% by weight of butyl acrylate having a viscosity number of approximately 75 cm³/g.

TABLE 4

| | | Styrene | Styrene | Styrene |
|---|---|---|---|---|
| | Styrene | content | content | content |
| | content | after | after | after |
| | after | 10 min | 20 min | 30 min |
| | 0 min | temper | temper | temper |
| Comparison A | <0.08 | 0.17 | 0.56 | 0.78 |
| Comparison B | — | — | — | — |
| 1 | <0.08 | <0.08 | <0.08 | <0.08 |
| 2 | <0.08 | <0.08 | 0.14 | 0.3 |
| 3 | <0.08 | 0.1 | 0.17 | 0.38 |
| 4 | <0.08 | <0.08 | <0.08 | <0.08 |
| 5 | <0.08 | <0.08 | 0.11 | 0.12 |
| 6 | <0.08 | <0.08 | 0.11 | 0.14 |
| 7 | <0.08 | <0.08 | 0.21 | 0.29 |
| 8 | n.d. | n.d. | n.d. | n.d. |
| 9 | <0.08 | <0.08 | <0.08 | 0.29 |
| 10 | <0.08 | <0.08 | <0.08 | <0.08 |
| 11 | <0.04 | <0.12 | <0.12 | <0.12 |
| (Comparison C) | | | | |
| 12 | | | | |
| (Comparison D) | — | — | — | — |
| 13 | <0.08 | 0.11 | 0.17 | 0.24 |
| 14 | n.d. | n.d. | n.d. | n.d. |

n.d. = not determined

3. Test Methods

The reported property values were determined as follows;

The residual monomer content was measured by gas-chomatographic head space analysis, a method for determining vaporizable constituents in liquids and solids (including monomers in thermoplastics).

The midpoint particle diameter of the spun fibre additive beads was determined via sieve analysis using an Alpine air jet sieving machine (model A 200 LS).

The viscosity number VN (also known as the Staudinger function) is the concentration-based relative viscosity change of a 0.5% solution of the copolymer in chloroform, based on the solvent, the flow times being determined in a suspended level Ubbelohde viscometer, Schott model No. 53203, and a 0c capillary according to DIN standard 51562 at 25° C. The solvent used was chloroform.

$$VN = ( \frac{t}{{t}_{0}} - 1 ) \cdot \frac{1}{c}$$

where
t=flow time of polymer solution in seconds
tₒ =flow time of solvent in seconds
c=concentration in g/100 ccm
   4. Production of Pellet Premixtures

Pellet premixtures consisting of a commercially available polyethylene terephthalate pellet (intrinsic viscosity IV 0.66 dl/g, about 0.3% by weight of TiO₂) and an inventive elongation-aiding agent as per the Example 6 recipe were produced as follows:

4.1. Compounding a Master Batch from 10% Additive and 90% PET

Preparation of Raw Materials

PET Pellet:

Crystallization and drying were done using a continuous TPE 50-5 drying range from Karl Fischer Industrieanlagen GmbH, Berlin, under the following technological conditions:
Drying air temperature: 160° C.
Drying air dewpoint: <-40° C.
Residence time: 5.5 h

Moisture content was repeatedly determined during drying using an Aquatrac moisture meter from Brabender. The moisture levels found were 10. to 30 ppm.

Elongation-Aiding Agent:

Drying was done in a batch dry-air dryer from Helios Geratebau fur Kunststofftechnik GmbH, Rosenheim, under the following conditions:
Temperature: 80° C.
Drying time: 5 hours
Drying air: dewpoint -40° C.
The moisture values found were 50-100 ppm.
   Compounding of Master Batch

Using a ZSK40 corotating twin-screw extruder from Coperion Werner und Pfleiderer, 10% by weight of elongation-aidirig agent was incorporated in the PET matrix under the following conditions (see Table 5):

TABLE 5
Extrusion conditions

| | |
|---|---|
| Extruder type | ZSK40 |
| Raw material | See above |
| preparation | |
| Metering | Gravimetric metering of PET and additive in |
| | intake zone via separate balances; metering |
| | line and funnel equipped with dry air feed |
| | (dewpoint: −40° C.) |
| Degassing | Vacuum |
| Throughput [kg/h] | 50 |
| Rotary speed [rpm] | 175 |
| Temperature | Zone 1: 260 |
| regime [° C.] | Zone 2: 270 |
| | Zone 3-Zone 10: 280 |
| Melt | 293 |
| temperature [° C.] | |

The melt mixture thus compounded was led through a waterbath and was pelletized using a strand pelletizer to form master batch pellet having a 10% by weight additive content.

4.2 Production of Ready-to-use Compound with 0.42% Additive Content

The ready-to-use compound was produced by blending in the master batch pellet from 4.1

Predrying of Raw Materials

The PET was dried under the same conditions as described above.

The master batch needed to produce the compound was crystallized and dried using-a continuous Karl Fischer drying range under the following conditions:
Drying air temperature: 105° C.
Drying air dewpoint: <-40° C.
Residence time in dryer: 8 h
Moisture content: <50 ppm
   Procedure

A ZSK40 corotating twin-screw extruder from Coperion Werner & Pfleiderer was used as per the following conditions of processing (Table 6).

TABLE 6
Extrusion conditions

| | |
|---|---|
| Extruder type | ZSK40 |
| Raw material | See above |
| preparation | |
| Metering | Gravimetric metering of PET and additive in |
| | intake zone via separate balances; metering |
| | line and funnel equipped with dry air feed |
| | (dewpoint: −40° C.) |
| Degassing | Vacuum |
| Throughput [kg/h] | 50 |
| Rotary speed [rpm] | 175 |
| Temperature | Zone 1: 260 |
| regime [° C.] | Zone 2: 265 |
| | Zone 3-Zone 10: 270 |
| Melt | 290 |
| temperature [° C.] | |

The melt mixture thus compounded was led through a waterbath and was pelletized using a strand pelletizer to produce a ready-to-use polyethylene terephthailate-additive compound with 0.42% by weight additive content in pellet form.

5. Spinning Trials with Elongation-Enhancing Agents

### Examples 15-17

Polyester chips (commercially available polyethylene terephthalate, intrinsic viscosity IV 0.67 dl/g, about 0.3% by weight of TiO₂) which had been crystallized and dried by means of a vacuum tumble dryer according to the following program:
5 h 115° C.
12 h 145° C.
5 h 160° C.
   were fed into a 6E24D-LTM single-screw extruder from Barmag AG, Remscheid, Germany. The respective elongation-aiding agent, which had previously been dried at 80° C. in a vacuum drying cabinet for 6 hours, was added to the polyester chips in a concentration of 0.6% by weight (based on total polymer) by gravimetric metering into the extruder intake. In the extruder, the two polymers were melted and fed at 288° C. by means of a metering gear pump through a product line having 16 SMX type static mixing elements from Sulzer AG, Zurich, Switzerland, at a throughput of 64.8 g/min and a pressure of about 220 bar to a spinnerette die pack. The spinnerette die pack contained (viewed in the direction of melt flow) a plurality of filters (1×650 mesh/cm², 5×1 600 mesh/cm², 60×16 800 mesh/cm², 1×40 000 mesh/cm², flow filter 10 μm (aluminium-bordered twilled dutch weave), 3×16 800 mesh/cm², 1×bordered supporting sieve 24 mesh, a distributor plate having 17% of free area, 1×16 800 mesh/cm², 1×1 600 mesh/cm²) and a spinnerette die plate 80 mm in diameter which has 36 capillary bores of 0.25 mm with a capillary length of 0.50 mm. The average residence time of the polymer melt from extruder exit to spinnerette die plate exit was about 7.5 min. The molten filaments emerging from the die plate were quenched by self-aspirated ambient air in a perforated tube. The quenched filaments were bundled by means of a slot-shaped spin-finishing stone at a point 1 800 mm away from the die plate, where they were spin finished with an emulsion consisting of 92% of water and 8% of spin-finishing composition (for example Lurol PT L220 from Goulston Technologies, INC. Monroe/USA) to a spin finish add-on of 0.35%. The filament sheet was subsequently entangled using an air jet (Heberlein PolyJet SP ECO 25-E-H132/CN) at an air pressure of 2.5 bar and wound up in a CW8 winding assembly from Barmag AG, Remscheid, Germany, at a winding speed of 4 500 m/min and a yarn tension of 25 to 27 g, to a linear density of about 145 dtex.

The results of the spinning trials and the particular elongation-aiding agents used are summarized in Table 6:

TABLE 6

| | | | Addi- | | | | | Co- |
|---|---|---|---|---|---|---|---|---|
| | Addi- | | tive | | Breaking | | MMA | efficient |
| Use | tive | | con- | Winding | elon- | Breaking | (extrusion | of fibre/ |
| example | as per | Meter- | tent | speed | gation | strength | waste) | fibre |
| [No.] | example | ing | [wt %] | [m/min] | [%] | [CN/tex] | [ppm] | friction |
| Ex. 15 | 6 | Solid | 0.60 | 4500 | 116.6 | 25.6 | 31 | 0.0645 |
| Ex 16 | 14 | Solid | 0.60 | 4500 | 111.9 | 26.5 | 12 | 0.0647 |
| Ex 17 | 12 | Solid | 0.60 | 4500 | 130.8 | 22.8 | 64 | 0.0607 |
| (Comparison) | (comparison) | | | | | | | |
| Ex 18 | 6 | Master | 0.60 | 4500 | 114.9 | 25.2 | 13 | n.d. |
| | | batch | | | | | | |
| Ex 19 | 6 | Solid | 0.42 | 4100 | 120.4 | 25.3 | 24 | 0.0654 |
| Ex 20 | 6 | None | 0.42 | 4100 | 129.3 | 23.9 | 10 | 0.0664 |
| | | or | | | | | | |
| | | mod. | | | | | | |
| | | chip | | | | | | |

The elongation and strength values are in an acceptable range in all examples. Remarkably, the elongation and strength values in Examples 18 and 20 are almost unchanged despite the additional thermal stress due to the preceding compounding steps, compared with the direct addition of the additive in Examples 15 and 19.

Example 17 (comparison) was observed to have a pronounced tendency to develop dropped ends due to undesired high-tension threads. The methyl methacrylate content of the wound-up POY fibre would be reduced by about 30% to 40% compared with that in the undrawn extrusion waste in all trials, since methyl methacrylate continues to fume out of the fibre during the cooling operation. The inventive examples have a distinctly reduced methyl methacrylate content in the ready-produced fibre as well, compared with the comparative example. The undesirable emission of methyl methacrylate is altogether reduced. This effect is all the more important in large scale industrial-plants wherein the molten mixture has travelled significantly longer distances. The elevated coefficient of friction in the inventive examples compared with Comparative Example 17 provides improved winding behaviour, since the tendency for the yarn to slough off and hence the formation of undesired threads high-tension threads is reduced. This makes use of costly specific facilities or winder technologies which are intended to prevent any sloughing off of flat yarns substantially redundant, or for the same spinning equipment good package build can be achieved at a higher winding speed compared with the prior art.

### Example 18 (Invention)

With otherwise unchanged settings, the master batch described under point 4.1 (premix composed of 10% additive as per Synthesis Example 6 and 90% PET), which had previously been dried at 160° C. in a tumble dryer for 6 hours, was added to the polyester chips in a concentration of 6.0% by weight (based on total polymer) by gravimetric metering into the extruder intake. An MMA content of less than 10 ppm in the master batch was found after drying; that is, very effective depletion of the initial MMA content has taken place under the drying conditions described. Evidently no degradation of the additive polymer has occurred. A drying performed below the glass transition point of the additive polymer, i.e. below about 115° C., would likely give rise to a distinctly higher methyl methacrylate content in the master batch. The results of the spinning trials are summarized in Table 5. Even after the elongation-aiding agent had been compounded, an unchanging high efficacy and good spinnability were observed, which documents the elongation-aiding agent's good thermal stability. The MMA contents in the extrusion waste and consequently in the fibre are very low, making for very low emissions in the spinning plant.

### Examples 19 and 20

Polymer throughput per spin pack was reduced to 59 g/min and the winding speed was reduced to 4 100 m/min. The additive as per Example 6 was added as a solid in a concentration of 0.4.2% by weight in Example 19. Example 20 utilized under otherwise identical conditions the additive as per Example 6 which had already been present in the modified polyethylene terephthalate chips in a concentration of 0.42% by weight, so that no addition step was required. Remarkably, the fibre's coefficient of friction was further increased compared with Example 19. The use of polyethylene terephthalate chips modified according to the invention makes it possible to employ the additive spinning process in conventional extruder spinning facilities which are not equipped with additive-specific mixing and metering units.

Methods of Measurement:

Intrinsic viscosity was determined at 25° C. on a solution consisting of 0.2 g of PET and 40 ml of 1:1 1,2-dichlorobenzene/phenol.

Breaking elongation and breaking strength were determined as described in WO 99/07927.

MMA contents of mixtures consisting of PET and elongation-aiding agent were determined by head space gas chromatography after extraction (sample about 3 g, 3 days at room temperature in 20 ml of dimethylformamide).

The fibre/fibre coefficients of friction were determined from computer-aided friction measurement using Rotschild F meter from Rothschild, Zurich, Switzerland, under the following conditions of measurement (Table 7):

TABLE 7

| Atmospheric | 22° C. | 65% relative |
|---|---|---|
| conditions: | | humidity |
| Measuring | Fibre/fibre | |
| arrangement: | Dynamic | |
| Wrap angle | 5 × 360° | (modified yarn |
| | | path) |
| Speed | 50 | m/min |
| Pre-tension | 5 | cN |
| Measuring time: | 2 | min |

(Measuring prescription of Diolen Industrial Fibers GmbH, Obernburg, Germany)

Residues of lubricants or initiator-derived products in the elongation-enhancing agent were determined by gas chromatography.

### Example 21

Silver Steel Test with Various Elongation-Aiding Agents

To this end, 2.5 g of the respective elongation-aiding agent were weighed into a test tube (L=160 mm, D=16 mm, wall thickness: 1 mm) and a silver steel rod (material: WN1.2210 according to DIN175, ground and polished, L=130 mm, D=5 mm) was dipped into the polymer. The test tube holding the sample and the rod was placed in a hot AL block at 300° C. for 3 h. Subsequently polymer remnants were detached from the rod with chloroform and the steel surface was visually inspected for black residues.

It is found that thermally stabilized elongation-aiding agents form deposits to a lesser extent, especially when they were produced completely without addition of lubricants (stearic acid and palmitic acid).

In this connection, the advantages of a degassing of the elongation-aiding agents prior to spinning become evident. As well as volatile monomers, the degassing step also removes higher-boiling concomitant and decomposition products (Table 8).

TABLE 8

| | | | Content of | |
|---|---|---|---|---|
| | | | initiator- | |
| | | Content of | derived | Result |
| | Lubricant | initiator- | product | Silver |
| Elongation- | (stearic + | derived | undecyl | steel test |
| aiding agent | palmitic) | product | laurate | visual |
| as per | content | 1 wt % | wt % | inspection |
| Comparison A | 0.031 + 0.022 | 0.053* | 0.019** | Many residues |
| Prior art | | | | |
| Example 6 | 0.021 + 0.031 | 0.047* | 0.018** | Many residues |
| Inventive | | | | |
| Thermally | | | | |
| stabilized | | | | |
| Example 6 | 0.017 + 0.032 | 0.038* | 0.017** | n.d. |
| Inventive | | | | |
| Thermally | | | | |
| stabilized | | | | |
| after | | | | |
| degassing | | | | |
| extrusion | | | | |
| **** | | | | |
| Example 11 | — | n.d. | n.d. | Little by way |
| (Comparison | | | | of residues |
| C), | | | | |
| not thermally | | | | |
| stabilized | | | | |
| Example 14 | — | <0.01*** | | Very little by |
| Inventive | | | | way of residues |
| Thermally | | | | |
| stabilized | | | | |

*Docosane content
**Undecyl laurate content
***Content of tert-butyl per-3-ethylhexanoate decomposition product
****ZSK70 twin-screw degassing extruder, 300 kg/h, one degassing zone about 850 mbar vacuum, 245-270° C. cylinder temperature, 210 rpm speed

Method of Determining the Lubricant Components Stearic Acid and Palmitic Acid and the Initiator-derived Products n-docosane and Undecyl Laurate:

The polymer was dissolved in dichloromethane which contained a known amount of myristic acid as an internal standard and precipitated with n-hexane. After filtration, the dissolving and precipitating operation was repeated on the filtration residue in order that the inclusion of analytes in the precipitated polymer may be substantially ruled out. The filtered-off polymer was repeatedly washed with little n-hexane. The precipitation filtrate was concentrated to dryness in a rotary evaporator and taken up with a defined amount of dichloromethane. Stearic acid, palmitic acid and n-docosane were quantified therein by capillary gas chromatography on an apolar 50 m poly(dimethylsiloxane) column and on the basis of a calibration according to the internal standard method. The undecyl laurate content was approximated by assignment with the n-docosane factor for lack of availability of pure substance.

Method of determining the decomposition products of tert-butyl per-2-ethylhexanoate:

A 6% solution of the polymer in dichloromethane was prepared and gas chromatographed directly on an apolar 15 m polydimethylsiloxane capillary column. No decomposition products of tert-butyl per-2-ethylhexanoate were detected, their retention time having been determined beforehand by targeted decomposition of the initiator. The detection limit was estimated at 0.01% by weight by analogy with substances whose chemical structure is similar to the likely decomposition products.

1. Elongation-enhancing agent which is amorphous and thermoplastically processible, formed from free-radically polymerized vinylic monomer and adapted to production of synthetic fibre from a melt-spinnable fibre-forming matrix polymer which is incompatible with said elongation-enhancing agent,
characterized in that
the elongation-enhancing agent is thermally stabilized by addition of an antioxidative substance, so that it contains in total not more than 6% by weight of decomposition products detectable using the gas-chromatographic head space method after thermal exposure at 290° C. under argon for 30 min.

2. Elongation-enhancing agent as per claim 1, characterized in that it contains a C₁- to C₁₂-alkyl acrylate as a comonomer and/or was polymerized in the presence of a molecular weight regulator which is an alkyl 3-mercaptopropionate, where alkyl represents linear or branched C₁-C₁₈ hydrocarbyl groups.

3. The elongation-enhancing agent according to claim 1, characterized in that it contains an antioxidative substance in an amount of 0.05% to 5% by weight.

4. The elongation-enhancing agent according to claim 1, characterized in that the antioxidative substance is octadecyl 3-(3,5-di-tert-butyl-4-hydroxyphenyl)propionate and/or is selected from the class of sterically hindered phenols and/or of divalent thio compounds and/or of trivalent phosphorus compounds and/or of sterically hindered piperidine derivatives.

5. The elongation-enhancing agent according to claim 1, characterized in that the antioxidative substance was added to the monomer mixture before or during the polymerization.

6. The elongation-enhancing agent according to claim 2, characterized in that a C₁- to C₁₂-alkyl acrylate is present in an amount of 1.5% to 15% by weight as a thermally stabilizing comonomer based on the total weight of the elongation-enhancing agent.

7. Elongation-enhancing agent according to claim 6, characterized in that n-butyl acrylate is present as a thermally stabilizing comonomer.

8. The elongation-enhancing agent according to claim 1, characterized in that it is polymerized from monomers of the general formula I 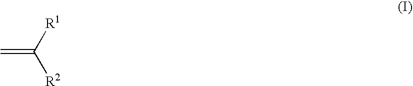
where R¹ and R² are the same or different and are each independently a substituent consisting of the optional atoms C, H, O, S, P and halogen atoms, the sum total of the molecular weight of R¹ and R² being at least 40 and at most 400 dalton.

9. The elongation-enhancing agent according to claim 1, characterized in that it is a thermally stabilized polymethyl methacrylate.

10. The elongation-enhancing agent of claim 1, characterized in that it is a copolymer formed from the following monomer units:
A=acrylic acid, methacrylic acid or CH₂═CR—COOR′, where R is a hydrogen atom or CH₃ group and R′ is a C₁₋₁₅-alkyl radical or a C₅₋₁₂-cycloalkyl radical or a C₆₋₁₄-aryl radical,
B=styrene or C₁₋₃-alkyl-substituted styrenes,
X=a C₁- to C₁₂-alkyl acrylate other than A.
the copolymer consisting of 60% to 98% by weight of A, 0% to 40% by weight of B, 0% to 15% by weight of X (sum total of A, B and X=100% by weight).

11. Elongation-enhancing agent as per claim 10, characterized in that it is a copolymer of methyl methacrylate and n-butyl acrylate.

12. Elongation-enhancing agent as per claim 10, characterized in that it is a copolymer of methyl methacrylate, styrene and n-butyl acrylate.

13. The elongation-enhancing agent of claim 1, characterized in that it is a copolymer of at least three of the following monomer units:
E=30% to 99% by weight of monomers selected from the group consisting of acrylic acid, methacrylic acid and compounds of the general formula CH₂═CR—COOR′, where R is a hydrogen atom or a CH₃ group and R′ is a C₁₋₁₅-alkyl radical or a C₅₋₁₂-cycloalkyl radical or a C₆₋₁₄-aryl radical, with optionally
F=0% to 50% by weight of monomers selected from the group consisting of styrene and C₁₋₃-alkyl-substituted styrenes, with optionally
G=0% to 50% by weight of monomers selected from the group of compounds consisting of compounds of the formula II, III, and IV, 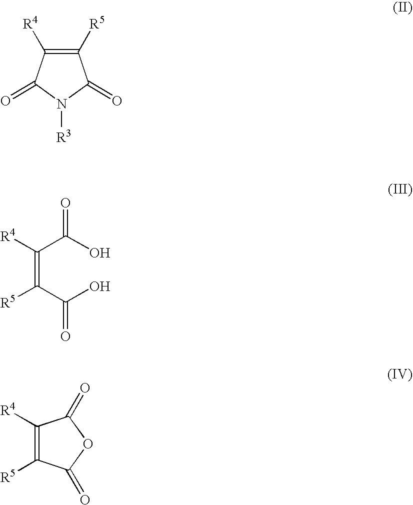
where R³, R⁴ and R⁵ are each a hydrogen atom or a C₁₋₁₅-alkyl radical or a C₅₋₁₂-cycloalkyl radical or a C₆₋₁₄-aryl radical,
with optionally
H=0% to 50% by weight of one or more ethylenically unsaturated monomers copolymerizable with E and/or with F and/or G from the group consisting of α-methylstyrene, vinyl acetate, acrylic esters, methacrylic esters other than E, acrylonitrile, acrylamide, methacrylamide, vinyl chloride, vinylidene chloride, halogen-substituted styrenes, vinyl ethers, isopropenyl ethers and dienes,
the sum total of E, F, G and H together being equal to 100% by weight of the polymerizable monomers.

14. Elongation-enhancing agent as per claim 13, characterized in that it is a terpolymer of methyl methacrylate, styrene and N-cyclohexylmaleimide.

15. The elongation-enhancing agent according to claim 1, characterized in that in that it is a copolymer of at least four of the following monomer units:
E=30% to 99% by weight of monomers selected from the group consisting of acrylic acid, methacrylic acid and compounds of the general formula CH₂═CR—COOR′, where R is a hydrogen atom or a CH₃ group and R′ is a C₁₋₁₅-alkyl radical or a C₅₋₁₂-cycloalkyl radical or a C₆₋₁₄-aryl radical, with optionally
F=0% to 50% by weight of monomers selected from the group consisting of styrene and C₁₋₃-alkyl-substituted styrenes, with
G=0% to 50% by weight of monomers selected from the group of compounds consisting of compounds of the formula II, III and IV, 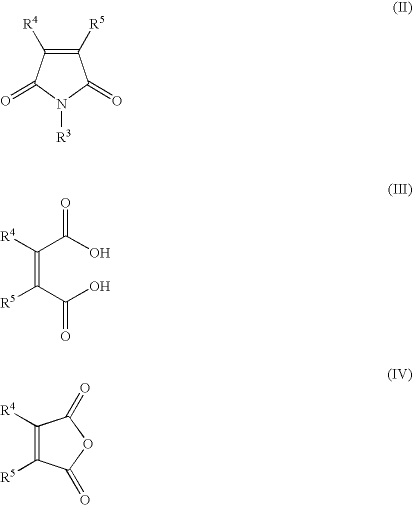
where R³, R⁴ and R⁵ are each a hydrogen atom or a C₁₋₅-alkyl radical or a C₅₋₁₂-cycloalkyl radical or a C₆₋₁₄-aryl radical,
with optionally
H=0% to 50% by weight of one or more ethylenically unsaturated monomers copolymerizable with E and/or with F and/or G from the group consisting of α-methylstyrene, vinyl acetate, acrylic esters, methacrylic esters other than E, acrylonitrile, acrylamide, methacrylamide, vinyl chloride, vinylidene chloride, halogen-substituted styrenes, vinyl ethers, isopropenyl ethers and dienes,
x=1.5% to 15% by weight of a C₁- to C₁₂-alkyl acrylate other than E
the sum total of E, F, G, H and X together being equal to 100% by weight of the polymerizable monomers.

16. Elongation-enhancing agent as per claim 15, characterized in that it is a copolymer of methyl methacrylate, N-cyclohexylmaleimide and n-butyl acrylate.

17. Elongation-enhancing agent as per claim 15, characterized in that it is a copolymer of methyl methacrylate, styrene, N-cyclohexylmaleimide and n-butyl acrylate.

18. The elongation-enhancing agent according to claim 1, characterized in that the elongation-enhancing agent was polymerized by simultaneous or successive multiple initiation.

19. A plastics pellet consisting essentially of the elongation-enhancing agent according to claim 1 and a melt-spinnable fibre-forming matrix polymer.

20. Plastics pellet according to claim 19, characterized in that the fibre-forming matrix polymer is a polyester, a polylactic acid, a polyamide or polypropylene.

21. Plastics pellet according to claim 20, characterized in that the melt-spinnable fibre-forming polyester is a polyethylene terephthalate, polyethylene naphthalate, polypropylene terephthalate or polybutylene terephthalate and may selectively contain up to 15 mol % of a copolymer and/or up to 0.5% by weight of a polyfunctional brancher component.

22. A process for producing the plastics pellet of claim 19, characterized in that the molten elongation-aiding agent, before or after it has been mixed into the melt of the matrix polymer, is transported through a degassing zone in which the melt is degassed, by application of a vacuum, before pelletization takes place.

23. Plastics pellet producible according to claim 22, characterized in that the pellet contains less than 0.8% by weight of monomer from the thermal decomposition of the elongation-enhancing agent, based on the weight fraction of the elongation-enhancing agent.

24. Use of the elongation-enhancing agent according to claim 1 as an additive in the production of synthetic fibre from a melt-spinnable fibre-forming matrix polymer which is a polyester, a polylactic acid, a polyamide or polypropylene.

25. Use according to claim 24, characterized in that the melt-spinnable fibre-forming polyester is a polyethylene terephthalate, polyethylene naphthalate, polypropylene terephthalate or polybutylene terephthalate and may selectively contain up to 15 mol % of a copolymer and/or up to 0.5% by weight of a polyfunctional brancher component.

26. A process for producing synthetic fibre in a melt-spinning process from a polymer blend formed from a melt-spinnable fibre-forming matrix polymer and an elongation-enhancing agent, characterized in that the fibre-forming matrix polymer has added to it at least one elongation-enhancing agent according to claim 1 in an amount of 0.05% to 5% by weight, based on the total weight of fibre-forming matrix polymer with this elongation-enhancing agent.

27. The process of claim 26, characterized in that the matrix polymer and the elongation-enhancing agent are introduced as a raw material in the form of the plastics pellet of claim 19 into the production process for producing synthetic fibre.

28. Process as per claim 26, characterized in that the addition of the elongation-enhancing agent to a melt-spinnable fibre-forming polyester takes place in the final stage of the polycondensation plant during the production of the polyester.

29. Process as per claim 26, characterized in that the addition of the elongation-enhancing agent to a melt-spinnable fibre-forming polyester takes place after the polyester melt has been discharged from the final stage of the polycondensation plant and is being transported to the direct spinning operation, the elongation-enhancing agent being melted by means of a side stream extruder and the molten elongation-enhancing agent being transported through a degassing zone in which the melt is degassed, by application of a vacuum, before the degassed melt is metered by means of a gear wheel metering pump into the stream of the polyester melt and mixed therewith by means of a static mixing sector.

30. The process of claim 26, characterized in that the spinning take-off speed is adjusted to at least 2 500 m/min.

31. The process of claim 26, characterized in that the fibre-forming matrix polymer is a thermoplastically processible polyester, such as polyethylene terephthalate, polyethylene naphthalate, polypropylene terephthalate or polybutylene terephthalate and may selectively contain up to 15 mol % of a copolymer and/or up to 0.5% by weight of a polyfunctional brancher component.

32. A synthetic fibre obtained by the process of claim 26.

33. A synthetic fibre, consisting essentially of a polymer blend formed from polyester and the elongation-enhancing agent according to claim 1, characterized in that the fibre contains less than 40 ppm of monomer from the thermal decomposition of the elongation-enhancing agent.

34. Use or further processing of the synthetic fibre of claim 32 in a drawing or draw-texturing operation.

35. Use of the synthetic fibre of claim 32 for producing staple fibre.

36. Use of the synthetic fibre of claim 32 for producing nonwovens.

37. Use of the synthetic fibre of claim 32 for producing industrial yams.

38. Use or further processing of the pellet of claim 19 to form synthetic fibre, the level of monomer from the thermal decomposition of the elongation-enhancing agent in the pellet being reduced by thermal conditioning of the pellet at a temperature at least 10° C. higher than the glass transition temperature of the elongation-enhancing agent to less than 0.3% by weight based on the weight fraction of the elongation-enhancing agent in the pellet prior to melting in the spinning extruder.

39. Use according to claim 38, characterized in that the pellet is thermally conditioned for at least 4 hours under vacuum, dry air or inert gas atmosphere.

40. The elongation-enhancing agent according to claim 1, characterized in that it contains not more than 0.05% by weight of residues from lubricant additives and/or not more than 0.06% by weight of residues from initiator-derived products.

41. Elongation-enhancing agent which is amorphous and thermoplastically processible, formed from free-radically polymerized vinylic monomer and adapted for production of synthetic fibre from a melt-spinnable fibre-forming matrix polymer which is incompatible with said elongation-enhancing agent, characterized in that it contains not more than 0.05% by weight of residues from lubricant additives and/or not more than 0.06% by weight of residues from initiator-derived products.
